(19) United States
(12) Patent Application Publication
(10) Pub. No.: US 2013/0035407 A1
(43) Pub. Date: Feb. 7, 2013

(54) USE OF POLYSILOXANES COMPRISING BRANCHED POLYETHER MOIETIES FOR THE PRODUCTION OF POLYURETHANE FOAMS

(71) Applicants: Matthias Lobert, Essen (DE); Sarah Schmitz, Shanghai (CN); Roland Hubel, Essen (DE); Martin Glos, Borken (DE); Carsten Schiller, Muelheim an der Ruhr (DE)

(72) Inventors: Matthias Lobert, Essen (DE); Sarah Schmitz, Shanghai (CN); Roland Hubel, Essen (DE); Martin Glos, Borken (DE); Carsten Schiller, Muelheim an der Ruhr (DE)

(73) Assignee: EVONIK GOLDSCHMIDT GMBH, Essen (DE)

(21) Appl. No.: 13/566,606

(22) Filed: Aug. 3, 2012

(30) Foreign Application Priority Data
Aug. 3, 2011 (DE) 102011109541.5

(51) Int. Cl. C08J 9/00; C09J 175/04; C09D 175/04; C08L 75/04

(52) U.S. Cl. 521/112

(57) ABSTRACT

The present invention relates to the use of polyethersiloxane compounds branched within the polyether moiety and preferably containing carbonate groups, as foam stabilizers in the production of polyurethane foams.

### FIELD OF THE INVENTION

The present invention relates to the use of polyethersiloxane compounds which have branching in one or more polyether moieties and which preferably contain carbonate groups, as foam stabilizers in the production of polyurethane foams.

### BACKGROUND OF THE INVENTION

Polyurethane foams (PU foams) are used in a wide variety of sectors because they have excellent mechanical and physical properties. The automobile industry and the furniture industry are a particularly important market for various types of PU foams, for example conventional flexible foams based on ether polyol and based on ester polyol, high resilience foams (also called HR foams or cold foams), rigid foams, integral foams and microcellular foams, and also foams having properties between those of these classifications, e.g., semirigid systems. By way of example, rigid foams are used as roof lining, ester foams are used for the internal cladding of doors, and also for die cut sun visors, and high resilience and flexible foams are used for seat systems and mattresses.

The typical method of production of polyurethane foams is based on generation of a gas which can foam the polymer as it is produced during the reaction of a liquid reaction mixture, typically composed of polyester polyol or of polyether polyol, and of isocyanate, stabilizer, catalyst, optionally blowing agent, and other ingredients. A cellular structure is formed during the course of the reaction and is supported by an appropriate stabilizer.

The stabilizer assumes various functions. For example, the stabilizer promotes and controls the nucleation of the gas bubbles, has a compatibilizing effect in relation to incompatible components in the reaction mixture, and moreover stabilizes the cells necessary for the foam during their production phase and right through to complete hardening of the foam.

Materials which have proved particularly suitable for the stabilization of polyurethane foams are block copolymers made of polysiloxane blocks which have been reacted with polyoxyalkylene units by means of processes known in the art to give corresponding block copolymers. The stabilizers used have different structure depending on the desired characteristics of the foam. In order to be useful as a polyurethane foam stabilizer, the polyoxyalkylene blocks and the polysiloxane block in the block copolymer must be present in a balanced ratio to one another and must have a specific structure optimized for the respective resultant characteristics of the foam.

The literature has already provided detailed descriptions of polysiloxane-polyoxyalkylene block copolymers which have different linear polyoxyalkylene moieties in the average molecule. In contrast, the use of branched polyoxyalkylene moieties in the structure of a [polyurethane] foam stabilizer has been described on relatively few occasions, and mostly in non-polyurethane applications.

WO 2010/003611 A1 and WO 2010/003610 A1, for example, disclose the use of polyhydroxy-functional polysiloxanes for increasing the surface energy of thermoplastics with resultant improvement in the printability/coatability of thermoplastic materials and molding compositions.

WO 2007/075927 A1 concerns organopolysiloxanes which have been functionalized with branched polyethers and which by virtue of their increased level of hydrophilic properties give improved dirt-repellency in the painted region. However, WO 2007/075927 A1 describes polysiloxane-polyoxyalkylene copolymers which are branched directly on the polysiloxane skeleton, with the aid of glycidol or hydroxyoxetanes.

JP 10-316540 discloses the reaction of methylhydrosiloxanes with allylpolyglycerols. The corresponding products are used as hair conditioners.

EP 1 489 128 and U.S. Patent Application Publication No. 2005/0261133 describe the syntheses of polysiloxanes which are modified with the aid of (poly)glycerol and which can be used not only in cosmetic formulations but also as agents inhibiting droplet formation in chemical plant-protection formulations.

DE 10 2006 031152 describes another application of polysiloxanes modified by means of hydroxyoxetane, where the products are used to improve separation properties in polymeric molding compositions.

Although many and various stabilizer structures have been described for use in polyurethane foam, there is a need for alternative foam stabilizers, the amounts used of which are preferably small, and which have stabilizing effect in the foam, and which tolerate the characteristics of formulations, e.g., the addition of NOPs (natural oil based polyols), fillers (calcium carbonate, melamine) or large amounts of a blowing agent, and/or have no adverse effect on the processability and mechanical properties of the resultant foam.

### SUMMARY OF THE INVENTION

The present invention provides foam stabilizers for polyurethane systems in which the amounts of the stabilizer used are preferably small. The foam stabilizers of the present invention have a stabilizing effect in the foam, and can tolerate the characteristics of formulations, e.g., the addition of NOPs (natural oil based polyols), fillers (calcium carbonate, melamine) or large amounts of a blowing agent, and/or have no adverse effect on the processability and mechanical properties of the resultant foam. The foam stabilizers of the present invention are suitable for permitting the production of stable fine-celled polyurethane foams which are open- or closed-celled as are required by the application.

Surprisingly, it has been found that compounds of formula (IV) which have at least one branching point in the polyether chain can be used as a foam stabilizer.

In one aspect, the present invention provides a process for producing polyurethane foams which is characterized in that a polysiloxane compound of formula (IV) is used as a foam stabilizer.

The present invention also provides a composition suitable for the production of polyurethane foams which comprises at least one polyol component and one catalyst catalyzing formation of a urethane bond or isocyanurate bond, and which optionally comprises a blowing agent, characterized in that it also comprises a polysiloxane compound of formula (IV). The composition of the present invention may optionally comprise further additives and an isocyanate component.

The present invention also provides polyurethane foams produced by the process according to the invention, and also the use of the polyurethane foams, or for the production of, furniture, refrigerator-insulation materials, other means of insulation or insulation sheets, packaging materials, sandwich elements, spray foams, single- & 1.5-component canister foams, wood-imitation products, modelling foams, packaging foams, mattresses, furniture cushioning, automobile-seat cushioning, headrests, instrument panels, automobile-interior cladding products, automobile roof lining, sound-deadening materials, steering wheels, shoe soles, carpet-backing foams, filter foams, sealant foams, sealants or adhesives.

The use, according to the invention, of compounds of formula (IV) as a foam stabilizer has the advantage that for example despite high ethylene oxide content within the structures these do not become crystalline because of the branching present. A first result of this is better processability, and a second result is that entirely novel properties of a material are made available.

By way of example, the increase in OH-functionality improves solvent compatibility.

The incorporation of a branched polyether also requires less catalysis, since the polyether content that can be incorporated into the polyethersiloxane per Si—H function present is higher.

### DETAILED DESCRIPTION OF THE INVENTION

The subject matter according to the invention is described below by way of example, but there is no intention to restrict the invention to the said examples of embodiments. Where ranges, general formulae or classes of compounds are mentioned below, these are intended to comprise not only the corresponding ranges or groups of compounds explicitly mentioned but also to comprise all subranges and subgroups of compounds which can result from extraction of individual values (ranges) or compounds. Where documents are cited for the purposes of the present description, the entire content of these, in particular in respect of the substantive matter in the context of which the document has been cited, is intended to be part of the disclosure of the present invention. Where percentages are stated, these are percent by weight data unless otherwise stated. Where average values are stated below, these are weight averages unless otherwise stated. Where parameters determined by measurement are mentioned below, the temperature and pressure at which the measurements were carried out are, unless otherwise stated, 25° C. and 101.325 Pa.

For the purposes of the present invention, a polyurethane foam (PU foam) is a foam obtained as reaction product based on isocyanates and polyols or compounds having isocyanate-reactive groups. Other functional groups can be formed besides the eponymous polyurethane, e.g., allophanates, biurets, ureas or isocyanurates. For the purposes of the present invention, PU foams are therefore not only polyurethane foams (PU foams) but also polyisocyanurate foams (PIR foams). Preferred polyurethane foams are flexible polyurethane foams, rigid polyurethane foams, viscoelastic foams, HR foams, semirigid polyurethane foams, thermoformable polyurethane foams or integral foams. The term polyurethane here is a generic term for a polymer produced from di- or polyisocyanates and from polyols or from other species reactive towards isocyanate, e.g., amines, and the urethane bond does not have to be the exclusive or predominant type of bond. Polyisocyanurates and polyureas are expressly included.

A feature of the process according to the invention for the production of polyurethane foams is that a polysiloxane compound of formula (IV)

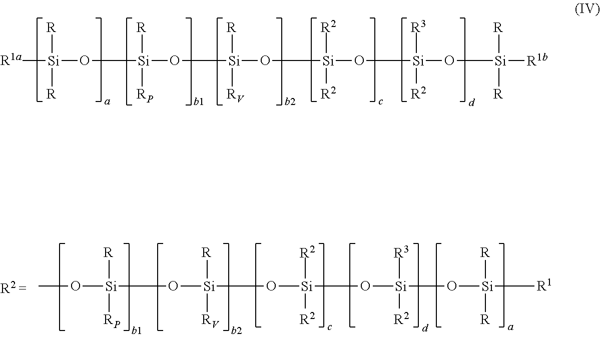

in which
a is mutually independently from 0 to 2000, preferably from 0 to 1000, in particular from 1 to 500,
b1 is mutually independently from 0 to 60, preferably from 0 to 15, in particular 0 or from 1 to 5,
b2 is mutually independently from 0 to 60, preferably from 0 to 15, in particular 0 or from 1 to 8,
c is mutually independently from 0 to 10, preferably from 0 to 6, with preference 0 or from 1 to 3,
d is mutually independently from 0 to 10, preferably from 0 to 5, with preference 0 or from 1 to 3,
R is at least one moiety from the group of linear, cyclic or branched, saturated or unsaturated hydrocarbon moieties having from 1 to 20 carbon atoms or is an aromatic hydrocarbon moiety having from 6 to 20 carbon atoms,
R¹ is mutually independently R or —OR⁴,
R^{1a} is mutually independently R, R_{V}, R_{P} or —OR⁴,
R^{1b} is mutually independently R, R_{V}, R_{P} or —OR⁴,
R³ is mutually independently R or a saturated or unsaturated, organic moiety optionally substituted with heteroatoms and preferably selected from the group of the alkyl, aryl, chloroalkyl, chloroaryl, fluoroalkyl, cyanoalkyl, acryloxyaryl, acryloxyalkyl, methacryloxyalkyl, methacryloxypropyl or vinyl moieties, particularly preferably a methyl, chloropropyl, vinyl or methacryloxypropyl moiety,
R⁴ is mutually independently an alkyl moiety having from 1 to 10 carbon atoms, preferably methyl, ethyl or isopropyl moiety,
R_{P} is mutually independently —OR⁴ or hydrogen or is unbranched polyether moieties bonded by way of Si—C bonds and made of alkylene oxide units having from 1-30 carbon atoms, of arylene oxide units and/or of glycidyl ether units with a weight-average molar mass from 200 to 30 000 g/mol, and/or an aliphatic and/or cycloaliphatic and/or aromatic polyester or polyetherester moiety with a weight-average molar mass from 200 to 30 000 g/mol bonded by way of Si—C bonds,
R_{V} are identical or different branched polyether carbonate moieties which comprise at least one branching unit based on hydroxyoxetane, on glycerol carbonate or on glycidol, and which optionally comprise other units based on alkylene oxides and/or on lactones, and/or on anhydrides, and/or on glycidyl ethers, and Rᵥ is preferably a moiety of formula (Ia) linked by way of an Si—C bond

—Z′(-Q-M1ᵢ₁-M2ᵢ₂-M3ᵢ₃-M4ᵢ₄-M5ᵢ₅-M6ᵢ₆-M7ᵢ₇-M8ᵢ₈-M9ᵢ₉-M10ᵢ₁₀-M11ᵢ₁₁-M12ᵢ₁₂-M13ᵢ₁₃-Jᵢ₁₄)ᵢ(Q-J)ₖ (Ia)

where
i=from 1 to 10, preferably from 1 to 5, preferably from 2 to 3
k=from 0 to 9, preferably from 0 to 5, preferably 0 or from 1 to 3
i+k=from 1 to 10, preferably from 1 to 5, particularly preferably from 1 to 3
i1 to i14=respectively mutually independently from 0 to 500, preferably from 0.1 to 100 and with particular preference from 1 to 30
Q=being identical or different, O, NH, N-alkyl, N-aryl or S, preferably O or NH, particularly preferably O,
Z′=any desired organic moiety, where each Q is bonded directly to a carbon atom of the organic moiety, where Z′ is preferably a linear, cyclic or branched, aliphatic or aromatic hydrocarbon moiety which can also comprise heteroatoms, and can also comprise other substituted, functional, saturated or unsaturated organic moieties,
J=is mutually independently hydrogen, a linear, cyclic or branched, aliphatic or aromatic, saturated or unsaturated hydrocarbon moiety having from 1 to 30 carbon atoms, a carboxylic acid moiety having from 1 to 30 carbon atoms or a functional, saturated or unsaturated organic moiety substituted with heteroatoms, preferably hydrogen, a linear or branched saturated hydrocarbon moiety having from 1 to 18 carbon atoms or a carboxylic acid moiety having from 1 to 10 carbon atoms, where the moiety J preferably involves a hydrogen atom, a methyl moiety or an acetyl moiety,

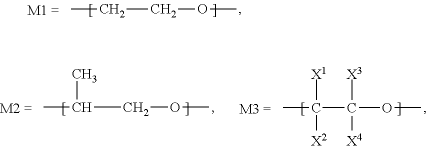

where X¹ to X⁴ are mutually independently hydrogen or linear, cyclic or branched, aliphatic or aromatic, saturated or unsaturated hydrocarbon moieties having from 1 to 50 carbon atoms, preferably from 2 to 50 carbon atoms, and can optionally comprise halogen atoms, with the proviso that the selection of X¹ to X⁴ is not such that M3 is identical with M1 or M2,

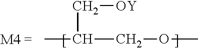

where Y is mutually independently a linear, cyclic or branched, aliphatic or aromatic, saturated or unsaturated hydrocarbon moiety having from 2 to 30 carbon atoms and can also comprise heteroatoms,

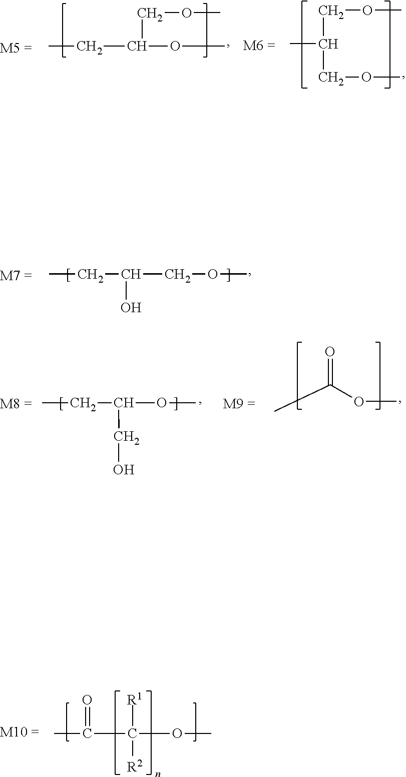

where R¹ and R² are mutually independently either hydrogen, alkyl group, alkoxy group, aryl group or aralkyl group, preferably having from 1 to 15 carbon atoms, and n are mutually independently from 3 to 8, where n, R¹ and R² in each M10 unit can be identical or different,

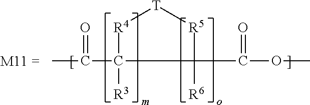

where R³, R⁴, R⁵ and R⁶ are mutually independently either hydrogen, alkyl groups, alkenyl groups, alkyliden groups, alkoxy groups, aryl groups or aralkyl groups and the moieties R⁴ and R⁵ can have cycloaliphatic or aromatic bridging by way of the fragment T, optionally the moieties R³ and R⁶ can form a bond (resulting in a double bond if m and o=1), m and o can be mutually independently from 1 to 8, the units with the indices o and m can be arranged randomly, preferably m=o=1, T is a divalent alkylene or alkenylene moiety (in this case m and o is preferably 1) and the indices m and o and the radicals T, R³, R⁴, R⁵ and R⁶ in each unit M11 can be identical or different,

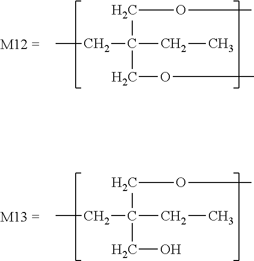

where the monomer units M1 to M13 are arranged in any desired ratios, either blockwise, in alternation, or randomly, or else can exhibit a distribution gradient, and where the monomer units M1 to M13, and in particular the units M1 to M4 are freely permutable, with the provisos that at least one unit M12, M5 or M6 is present for which there is no moiety J directly adjoining at any end and there is at least one unit selected from M1, M2 and M3 adjoining at each end, and that two monomer units of the type M9 do not occur in succession, where on average at least one moiety R_{V} is present per molecule of formula (IV),
with the proviso that the sum of b1 and b2=b, that the average number Σa of the D units per molecule of the formula (IV) is not greater than 2000, preferably not greater than 1000 and with preference not greater than 500, and the average number Σb of the R_{P}- and R_{V}-bearing units per molecule is not greater than 100, preferably not greater than 60, and the average number Σc+d per molecule is not greater than 20, preferably not greater than 10 and preferably not greater than 5, and
averaged over all of the compounds obtained of the formula (IV), at most 20 mol %, preferably less than 10 mol %, particularly preferably 0 mol %, of the moieties R_{P}, R¹, R^{1a} or R^{1b} are of the type —OR⁴, is used as foam stabilizer.

The compounds of formula (IV) can include random copolymers, alternating copolymers or block copolymers. It is also possible to form a gradient by virtue of the sequence of the side chains along the main silicone chain. The arrangement can have, in any desired sequence in the polysiloxane chain, to the extent that these are present, the a units of the formula

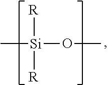

the b1 units of the formula

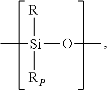

the b2 units of the formula

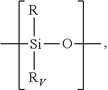

the c units of the formula

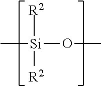

and also
the d units of the formula

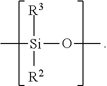

It is particularly preferable that a>0, b≧2 and R¹=R^{1a}=R^{1b}.

It is preferable that i9>0, preferably from 0.1 to 100, with preference from 0.5 to 50 and with particular preference from 1 to 10.

The structure of formula (IV) in the polysiloxane compounds is preferably such that Σi5+i6≧i+1, preferably Σi12+i5+i6≧i+1.

The moiety R_{V} preferably comprises at least one structural unit produced by direct bonding of the monomer unit M9 to a unit M5, M6, M7 or M8.

The number of the moieties J in R_{V} depends on the number of branching points, i.e., on the number of units M12, M5 and M6, and also on the indices i and k. The index i14 depends on the number of units with the index i12, i5 and i6 and preferably complies with the condition i14=1+(i12+i5+i6).

The properties of the polysiloxane according to the invention can be influenced through different contents of M1 and M2 in the moiety R_{V}. For example, the selection of suitable M1:M2 ratios can be used to control the level of hydrophobic or hydrophilic properties of the polysiloxane according to the invention, specifically because the M2 units have a higher level of hydrophobic properties than the M1 units.

The hydrocarbon moieties Z′ can preferably comprise halogens as substituents. In some embodiments, the hydrocarbon moieties Z′ can comprise nitrogen and/or oxygen as heteroatoms, preferably oxygen. Particularly preferred hydrocarbon moieties Z′ comprise no substituents and no heteroatoms and very particularly preferably comprise from 2 to 20 carbon atoms.

Compounds of formula (IV) in which b1 is at least 1 are advantageously used in systems which require compatibilization, but if b1 is zero it is also possible to achieve any necessary compatibilization through the intrinsic structure of the branched polyether carbonate.

Particularly preferred compounds of formula (IV) are those in which two or more of the preferred ranges mentioned, preferably all of the preferred ranges, have been combined.

The polysiloxane compounds of formula (IV) are preferably obtainable by the process described below.

The expression “branched polyether” means a polyether which is preferably a polyether carbonate in which not only the main chain but also at least one side chain comprises polyether structures and optionally polyether carbonate structures.

A feature of the process is that the process comprises the following steps:
(a) provision of branched polyethers which comprise at least one olefinically unsaturated group, at least one branching point (unit M12, M5 or M6) and preferably at least one structural unit —O—C(O)—O—,
(b) provision of SiH-functional siloxanes, and
(c) reaction of the SiH-functional siloxanes from (b) with the branched polyethers having at least one olefinically unsaturated group from step (a) with formation of SiC bonds.

Step (a):

Branched polyethers provided/used which comprise at least one olefinically unsaturated group and preferably at least one structural unit —O—C(O)—O— preferably comprise polyethers of formula (I)

Z-(-Q-M1ᵢ₁-M2ᵢ₂-M3ᵢ₃-M4ᵢ₄-M5ᵢ₅-M6ᵢ₆-M7ᵢ₇-M8ᵢ₈-M9ᵢ₉-M10ᵢ₁₀-M11ᵢ₁₁-M12ᵢ₁₂-M13ᵢ₁₃-Jᵢ₁₄)ᵢ(Q-J)ₖ (I),

where
i=from 1 to 10, preferably from 1 to 5, preferably 1,
k=from 0 to 9, preferably from 0 to 5, preferably 0 or from 1 to 3,
i+k=from 1 to 10, preferably from 1 to 5, particularly preferably 1,
i1 to i12=respectively mutually independently from 0 to 500, preferably from 0 to 100 and with particular preference from 0.1 to 30,
Z=any desired terminal unsaturated organic moiety, preferably terminal unsaturated, linear, cyclic or branched, aliphatic or aromatic hydrocarbon moiety, which can also comprise heteroatoms, and can also comprise other substituted, functional, saturated or unsaturated organic moieties,
Q=O, NH, N-alkyl, N-aryl or S, preferably O or NH, particularly preferably O,
J is mutually independently hydrogen, a linear, cyclic or branched, aliphatic or aromatic, saturated or unsaturated hydrocarbon moiety having from 1 to 30 carbon atoms, a carboxylic acid moiety having from 1 to 30 carbon atoms or a functional, saturated or unsaturated organic moiety substituted with heteroatoms, preferably hydrogen, a linear or branched saturated hydrocarbon moiety having from 1 to 18 carbon atoms or a carboxylic acid moiety having from 1 to 10 carbon atoms, where the moiety J preferably includes a hydrogen atom, a methyl moiety or an acetyl moiety,
M1 to M13 are as defined above in formula (Ia), where the monomers M1 to M13 can be arranged in any desired ratios, either blockwise, in alternation, or randomly, or else can exhibit a distribution gradient, and where in particular the monomers M1 to M4 are freely permutable, with the provisos that preferably at least one unit M12, M5 or M6 is present for which there is no moiety J directly adjoining at any end, and that two monomer units of the type M9 do not occur in succession.

In some embodiments, it is preferable that i9>0, preferably being from 0.1 to 100, with preference from 0.5 to 50 and with particular preference from 1 to 10.

The moiety J in formula (I) is preferably a hydrogen atom, a methyl moiety or an acetyl moiety. The sum Σi5 to i13 is preferably ≧i+1, with preference ≧i+2. The index i14 depends on the number of units with the index i12, i5 and i6 and preferably complies with the condition i14=1+(i12+i5+i6).

The branched polyether of formula (I) preferably comprises at least one structural unit produced by direct bonding of the monomer unit M9 to a unit M5, M6, M7 or M8.

The number of the moieties J in the polyether of the formula (I) depends on the number of branching points, i.e., on the number of units M5, M6 and M12, and also on the indices i and k.

The hydrocarbon moieties Z can preferably comprise halogens as substituents. In some embodiments, the hydrocarbon moieties Z can comprise nitrogen and/or oxygen as heteroatoms, preferably oxygen. Particularly preferred hydrocarbon moieties Z comprise no substituents and no heteroatoms and very particularly preferably comprise from 2 to 20 carbon atoms.

In some embodiments, it is preferable that one of the monomer units M1, M2, M7 or M8, with preference M1 or M2, forms the final member of a monomer chain.

A particularly advantageous embodiment can have i1 greater than 0 and i2, i3 and i4 equal to 0.

The branched polyether to be hydrosilylated is preferably composed of a suitable starter and of various monomer units M.

In a preferred method for providing the branched polyethers, in particular the branched polyethers of formula (I), starters of formula (II)

Z(Q-H)ⱼ (II)

where
Q=O, NH, N-alkyl, N-aryl or S, preferably O or NH, particularly preferably O,
j=from 1 to 10, preferably from 1 to 5, particularly preferably from 1 to 3, and Z is as defined above,
are alkoxylated (polymerized), wherein the (alkoxylation) reagent used comprises at least one branching agent, preferably glycerol carbonate, hydroxyoxetane or glycidol, preferably glycerol carbonate, and also preferably a reagent different from the branching agent, in particular an alkylene oxide.

If glycerol carbonate is used as sole reagent, the starter Z(Q-H)ⱼ is preferably a polyether alcohol.

The starter (II) is preferably an alkyl, aryl or aralkyl compound in which j=from 1 to 3 and which has α-hydroxy functionality and w-unsaturation. The starters (II) preferably include alkyl, aryl or aralkyl compounds in which j=from 1 to 5, preferably j=from 1 to 3, and which have α-(Q-H)-functionality, preferably α-hydroxy-functionality and ω-unsaturation. These starters preferably include (meth)allylic compound. Where the expression “(meth)allylic” is used, this comprises respectively “allylic” and “methallylic”. Where allylic starters are mentioned for the purposes of this application, the expression not only includes methallylic analogues, but also the allylic compounds can be used as starters.

If starters (II) used comprise those in which j=1, these preferably have a structure of formula (II) in which Q=O.

Preference is given to use of starters of formula (II) in which Z═CH₂═CH—CH₂-QH, CH₂═CH—CH₂—O—CH₂—CH₂-QH, CH₂═CH-QH, CH₂═CH—(CH₂)₄-QH or CH₂═CH—(CH₂)₉-QH, where Q is respectively preferably O, or Z=polyether started with one of the starters mentioned, e.g., allyl-alcohol-started polymers of ethylene oxide and/or propylene oxide and/or of other alkylene oxides and/or of glycidyl ethers.

Allyl alcohol or 2-allyloxyethanol are particularly preferably used as mono-hydroxyfunctional allylic starters of formula (II), very particular preference being given to allyl alcohol. However, it is also possible to use the corresponding methallyl compounds, e.g., methallyl alcohol or methallyl polyalkylene oxides.

Examples of mono-hydroxyfunctional starters of formula (II) which comprise an aromatic moiety Z are allyl- and methallyl-substituted phenol derivatives.

Particular examples of α-hydroxy-ω-alkenyl-substituted starters used with preference are 5-hexen-1-ol and 10-undecen-1-ol, particular preference being given here to 5-hexen-1-ol.

Examples of suitable cyclic unsaturated, hydroxy-functional compounds are 2-cyclohexen-1-ol, 1-methyl-4-isopropenyl-6-cyclohexen-2-ol and 5-norbornene-2-methanol.

As can be seen from formula (II), it is also possible to use starters, in particular allylic starters, according to formula (II) where j>1, e.g., dihydroxy-functional (j=2), trihydroxy-functional (j=3) or else polyhydroxy-functional (j>3) starters. These have increased polydispersities as hydroxy-functionality increases, and this can also have an advantageous effect on the physical properties of the final products. For example, higher branching content gives lower viscosity of the resultant products.

These polyhydroxy-functional starters preferably include monoallylically etherified di-, tri- or polyols, e.g., monoallyl ethers of glycerol, of trimethylolethane and of trimethylolpropane, monoallyl or mono(methallyl)ethers of di(trimethylol)ethane, di(trimethylol)propane and of pentaerythritol. Particular preference is given to the starter according to formula (II) where j>1 derived from a compound from the group consisting of 5,5-dihydroxymethyl-1,3-dioxane, 2-methyl-1,3-propanediol, 2-methyl-2-ethyl-1,3-propanediol, 2-ethyl-2-butyl-1,3-propanediol, neopentyl glycol, dimethylpropane, glycerol, trimethylolethane, trimethylolpropane, diglycerol, di(trimethylolethane), di(trimethylolpropane), pentaerythritol, di(pentaerythritol), anhydroenneaheptitol, sorbitol and mannitol. It is very particularly preferable to use trimethylolpropane monoallyl ether or glycerol monoallyl ether as di- or polyhydroxy-functional allylic starter compounds.

It is also possible to use cyclic, polyhydroxy-functional starter compounds as polyhydroxy-functional starters of the formula (II), for example 5-norbornene-2-dimethanol and 5-norbornene-2,3-dimethanol.

The method of production of the branched polyethers is preferably such that the starter is reacted with one or more alkylene oxides, with one or more branching agents and optionally with one or more glycidyl ethers. This reaction can use the respective pure materials or can use a mixture of one or more of the starting materials. The steps of the reaction can take place in any desired sequence, and it is thus possible to obtain either random structures or arbitrarily select structures of the main polyether chain or else gradient-type or block-type structures.

The branched polyether provided with a hydrosilylazable group can be produced by way of a three-stage, ring-opening polymerization process by the one-pot method. In a preferred method for producing the branched polyethers, the starter is first reacted with one or more alkylene oxides which differ from the branching agents, a reaction then takes place with branching agents, in particular glycerol carbonate, hydroxyoxetane or glycidol, and it is preferable that a further reaction then takes place with alkylene oxides which differ from the branching agents, and/or with glycidyl ethers. The steps can also be repeated a number of times.

In some embodiments, it is also possible to interrupt the process after each of the three steps. The respective product obtained as intermediate can be drawn off and stored until the further reaction takes place, but it can also be reacted further in the same, or another suitable, reaction vessel. The steps do not have to be carried out in immediate succession, but an excessive storage time for the intermediates can adversely affect the quality of the final product.

If an allyl polyether is used as starter, it is possible to omit the first alkoxylation step.

In order to ensure that well-defined structures are obtained, the reaction preferably takes the form of anionic ring-opening polymerization with controlled monomer addition.

A simultaneous addition reaction of alkylene oxides and/or glycidyl ethers with branching agents, in particular glycerol carbonate, can likewise be carried out, but is less preferred because of the pressure increase due to liberation of CO₂ during the glycerol carbonate reaction. It is therefore preferable to avoid any simultaneous addition reaction of glycerol carbonate and alkylene oxides and/or glycidyl ethers.

Alkylene oxides used can generally comprise any of the alkylene oxides known to the person skilled in the art, in pure form or in any desired mixture, where these give the monomer units M1, M2 or M3 defined in formula (I). In some embodiments, it is preferable to use ethylene oxide, propylene oxide, 1,2-butylene oxide, 2,3-butylene oxide, isobutylene oxide, octene 1-oxide, decene 1-oxide, dodecene 1-oxide, tetradecene 1-oxide, hexadecene 1-oxide, octadecene 1-oxide, C20/28 epoxide, alpha-pinene epoxide, cyclohexene oxide, 3-perfluoroalky-1,2-epoxypropane and styrene oxide. In some embodiments, it is particularly preferable to use ethylene oxide, propylene oxide, dodecene 1-oxide and styrene oxide. In other embodiments, it is very particularly preferable to use ethylene oxide and propylene oxide, which correspond to the monomer units M1 and respectively M2 defined in formula (I).

Any glycidyl ethers used give the monomer units M4 mentioned in formula (I), and these can have alkyl, aryl, alkaryl or alkoxy substitution. The expression “alkyl” preferably means linear or branched C₁-C₃₀, for example C₁-C₁₂ or C₁-C₈, alkyl moieties or the corresponding alkenyl moieties. The expression “alkyl” particularly preferably means methyl, ethyl, propyl, butyl, tert-butyl, 2-ethylhexyl, allyl or C₁₂-C₁₄. The expression “aryl” preferably means phenyl glycidyl ether and the expression “alkaryl” preferably means o-cresyl glycidyl ether, p-tert-butylphenyl glycidyl ether or benzyl glycidyl ether. The expression “alkoxy” preferably means methoxy, ethoxy, propoxy, butoxy, or phenylethoxy and comprises from 1 to 30 alkoxy units or a combination of two or more alkoxy units.

In some embodiments, it is also possible to use polyfunctional glycidyl ethers, e.g., 1,4-butanediol diglycidyl ether, 1,6-hexanediol diglycidyl ether, cyclohexanedimethanol diglycidyl ether, neopentyl glycol diglycidyl ether, polypropylene glycol diglycidyl ether, polyethylene glycol diglycidyl ether, polyglycerol 3-glycidic ether, glycerol triglycidic ether, trimethylolpropane triglycidyl ether or pentraerythritol tetraglycidyl ether, to produce the branched polyether carbonates. The use of tri- or tetrafunctional monomers of this type also gives branched structural elements.

In order to construct branched polyethers having the monomer units M10 and M11, polyetherester copolymers made of alkylene oxides and of lactones and/or of anhydrides can be incorporated into the main skeleton of the polyether carbonate. Copolymers of this type are known from the prior art. Copolymers made of alkylene oxides and of lactones are described, for example, in U.S. Pat. Nos. 2,962,524, 3,312,753, 3,689,531, 4,291,155, 5,525,702, 3,689,531, 3,795,701, and 2,962,524, as well as EP 2 093 244. Copolymers made of alkylene oxides and of cyclic anhydrides are described, for example, in DE 69532462, U.S. Pat. Nos. 4,171,423, 3,374,208, and 3,257,477, and EP 2 093 244. All of the abovementioned references and the disclosures cited as prior art therein are hereby incorporated as reference and are considered to be part of the disclosure of the present invention.

The polyetherester copolymers discussed can be produced by the processes described in the abovementioned patents and used as starters for the synthesis of branched polyether carbonates. It is also possible, however, to begin by producing a branched polyether carbonate from any desired starter alcohol with alkylene oxides and glycerol carbonate, and then to react this to give polyetherester copolymers by the reactions described in the patent literature cited above.

Where lactones are used as starting materials suitable for the ring-opening polymerization process, it is preferable to use those of the formula (III)

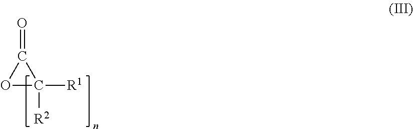

where R¹ and R² can be mutually independently hydrogen, alkyl groups, alkoxy groups, aryl groups or aralkyl groups, and n=from 3 to 8, where these are copolymerized by ring-opening polymerization to give polyetherester carbonates.

Suitable lactones are preferably those selected from the group consisting of γ-butyrolactone, δ-valerolactone, ε-caprolactone, ζ-enantholactone, η-caprylolactone, methyl-ε-caprolactone, dimethyl-ε-caprolactone, trimethyl-ε-caprolactone, ethyl-ε-caprolactone, isopropyl-ε-caprolactone, n-butyl-ε-caprolactone, dodecyl-ε-caprolactone, methyl-ζ-enantholactone, methoxy-ε-caprolactone, dimethoxy-ε-caprolactone and ethoxy-ε-caprolactone. Preference is given to use of ε-caprolactone, methyl-ε-caprolactone and trimethyl-ε-caprolactone, particularly ε-caprolactone.

Where cyclic anhydrides are used as starting materials for the ring-opening polymerization process, it is preferable to use those of formula (V)

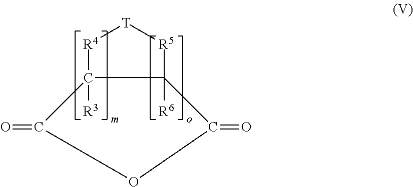

where R³, R⁴, R⁵ and R⁶ can be mutually independently hydrogen, alkyl groups, alkenyl groups, alkoxy groups, alkyliden groups, aryl groups or aralkyl groups, m and o independently as defined above, optionally the moieties R³ and/or R⁶ can be absent, optionally the moieties R³ and/or R⁶ can form a bond (resulting for example in a double bond if m and o=1), the hydrocarbon moieties R⁴ and R⁵ can have cycloaliphatic or aromatic bridging by way of the fragment T, and T can be a divalent alkylene or divalent alkenylene moiety, which can have further substitution, further one of the moieties R³, R⁴, R⁵ or R⁶ can be absent, for example if one of the organic moieties is an alkyliden moiety the other respective geminal moiety is absent, for example if R³ is methylidene (═CH₂), R⁴ is absent. Examples of preferred cyclic anhydrides are succinic anhydride, maleic anhydride, itaconic anhydride, glutaric anhydride, adipic anhydride, citraconic anhydride, phthalic anhydride, hexahydrophthalic anhydride and trimellitic anhydride, and also polyfunctional anhydrides such as pyromellitic dianhydride, benzophenone-3,3′,4,4′-tetracarboxylic dianhydride, and 1,2,3,4-butanetetracarboxylic dianhydride, or homo- or copolymers of maleic anhydride polymerized by a free-radical route with ethylene, isobutylene, acrylonitrile, vinyl acetate or styrene. Especially preferred anhydrides are succinic anhydride, maleic anhydride, itaconic anhydride, glutaric anhydride, adipic anhydride, citraconic anhydride, phthalic anhydride and hexahydrophthalic anhydride.

When lactones and/or cyclic anhydrides are used, these, too, can respectively be used alone or in any desired combination.

The process according to the invention preferably uses, as branching agent, glycerol carbonate, glycidol and/or hydroxyoxetane. For the purposes of the present invention, a branching agent is a molecule which after reaction for inclusion into the polyether skeleton provides at least two reactive groups at which further chain extension can occur. The glycidol and the glycerol carbonate introduce, into the polyether moiety R_{V}, the monomer units M5 to M8 defined in formula (I), and the glycerol carbonate moreover optionally introduces the monomer unit M9. The hydroxyoxetanes introduce the monomer units M12 and M13.

Where hydroxyoxetanes are used as branching agents, these preferably involve a 3-alkyl-3-(hydroxyalkyl)oxetane, a 3,3-di(hydroxyalkyl)oxetane, a 3-alkyl-3-(hydroxyalkoxy)oxetane, a 3-alkyl-3-(hydroxyalkoxyalkyl)oxetane or a dimer, trimer or polymer of a 3-alkyl-3-(hydroxyalkyl)oxetane, a 3,3-di(hydroxyalkyl)oxetane, a 3-alkyl-3-(hydroxyalkoxy)oxetane or a 3-alkyl-3-(hydroxyalkoxyalkyl)oxetane. “Alkyl” here preferably is linear or branched C₁-C₃₀ alkyl or C₁-C₃₀ alkenyl moieties. The expression “alkyl” particularly preferably means methyl or ethyl. The expression “alkoxy” preferably means methoxy, ethoxy, propoxy, butoxy, or phenylethoxy and comprises up to 20 alkoxy units or a combination of two or more alkoxy units.

As hydroxyoxetane, it is preferable to use 3-methyl-3-(hydroxymethyl)oxetane, 3-ethyl-3-(hydroxymethyl)oxetane, or trimethylolpropaneoxetane (3,3-di(hydroxymethyl)oxetane). It is also possible to use mixtures of said compounds. It is particularly preferable to use trimethylolpropane oxetane.

To produce the branched polyethers, one or more branching points is/are introduced into the polyether skeleton with the aid of one or more branching agents, preferably glycerol carbonate. As little as 1 mol of branching agent per mole of QH groups, preferably hydroxy groups, of the starter is theoretically sufficient. However, since the alkaline-catalyzed reaction of glycerol carbonate does not take place exclusively with nucleophilic attack on the CH₂ group of the carbonate ring, but instead the nucleophilic attack also takes place on the carbon of the carbonate group, carbonate esters are also formed. In some embodiments, it is therefore preferable to use at least 2 mol of branching agent in relation to 1 mol of the QH groups, preferably hydroxy groups, of the starter (II) used, in order to ensure a sufficient degree of branching and optionally content of carbonate ester groups.

In order to keep the degree of branching controllable, it can be advantageous to place an upward limit on the content of branching agent. An ideal index has proved to be the percentage molar content of branching agent, based on the molar content of the entirety of all of the monomers of which the polyether carbonate skeleton is composed, ignoring the mole of starter alcohol. This molar content should preferably be at most 80 mol %, particularly preferably at most 50 mol % and very particularly preferably at most 35 mol %.

To produce the branched polyethers, the QH groups, preferably hydroxy groups, of the preferably allyl-functional starters are preferably at least to some extent deprotonated by alkali metal hydroxides or alkali metal alkoxides, preferably sodium methoxide. The amount used of alkali metal hydroxide or of alkali metal alkoxides is preferably from 5 to 25 mol %, with preference from 10 to 15 mol %, based on the number of QH groups, preferably OH groups, of the starters used.

The resultant mixture made of alcohols and of alcoholates is reacted in the first step with one or more monomers suitable for the ring-opening polymerization process, preferably alkylene oxides, preferably at a temperature of from 80° C. to 200° C., preferably from 90° C. to 170° C. and particularly preferably from 100° C. to 125° C. The reaction preferably takes place at pressures in the range from 0.001 bar to 100 bar, with preference in the range from 0.005 bar to 10 bar and with very particular preference from 0.01 bar to 5 bar (in each case absolute pressures).

After the preferably quantitative-reaction of the monomers, preferably alkylene oxides, there can optionally be a following deodorization step in order to remove traces of unreacted monomers. In the case of this type of deodorization step, the reactor is preferably evacuated at the temperature, resulting from the polymerization step or alkoxylation step, preferably to a vacuum of less than or equal to 100 mbar, particularly preferably to a vacuum of less than or equal to 60 mbar and particularly preferably to a vacuum of less than or equal to 30 mbar. In the second step, the branching agent, preferably the glycerol carbonate, is introduced, preferably at a temperature of from 120° C. to 220° C., particularly preferably from 140° C. to 200° C. and very particularly preferably at a temperature from 160° C. to 180° C., into the reaction mixture in the evacuated reactor.

The reaction of the glycidol or hydroxyoxetane branching agents is already known from the prior art, e.g., WO 2010/003611, and can be carried out as described in that document. It is preferable to carry out the reaction by a method based on WO 2010/003611.

The ratio of glycerol-carbonate-based branching units M5-M8 to carbonate ester segments M9 can be regulated through the addition rate of the branching agent, in particular of the glycerol carbonate, and through the selected reaction temperature. The greater the addition rate of the branching agent and/or the lower the temperature, the higher the content of M9 units. In some embodiments, it is preferable that the branching agent is added at a rate of from 0.1 to 10 mol/h, based on the number (mols) of the (QH) groups of the starters used, with preference from 0.5 to 5 mol/h, and with particular preference from 1 to 2.5 mol/h.

The reaction of the glycerol carbonate can be discernible to some extent through the liberation of CO₂ and accordingly through a pressure increase in the reactor. The pressure increase can be countered by continuous or periodic depressurization. It is preferable to select the addition rate of the glycerol carbonate in such a way that the pressure in the reactor never exceeds a value of 2 bar gauge pressure.

The reaction in the second step is preferably followed, after a period of after-reaction (identical conditions without further addition of branching agent) of from 1 min to 20 h, with preference from 0.1 h to 10 h and with particular preference from 1 h to 5 h, starting at the final addition of branching agent, by a further reaction, as the third step, with monomers suitable for the ring-opening polymerization process, in particular alkylene oxides. The conditions correspond to those for the polymerization or alkylene oxide addition process of the first step.

In all three steps, the (living) anionic ring-opening polymerization process is controlled via the rapid exchange of the protons between the alcohol groups and alcoholate groups of the growing chains. Since each mole of branching agent incorporated by reaction generates an additional hydroxy group, the process results in a reduction of the effective concentration of alcoholate ions. As a result of this, the reaction rate in the third step can be slower than in the first step. In order to take account of this effect, it can be advantageous to add more catalyst after the second step. It is also possible, of course, to add more catalyst after the first step in order to achieve faster reaction of the glycerol carbonate, but this is less preferred.

The low-molecular-weight alcohol formed from the reaction of the catalyst with the molecule to be deprotonated can be removed by distillation either during the first step or else during the third step, in vacuo. However, it is distinctly preferable to avoid at all times any distillation to remove the alcohol resulting from the catalysis, since this step would increase the cost of plant and therefore also require capital expenditure. Since the quality of the final product is not adversely affected by the presence of the ancillary component(s), it is preferable to omit the step.

Once the third step has ended, it can be followed by a neutralization step in which the alkali is, for example, neutralized by addition of corresponding amounts of inorganic acids such as phosphoric acid or else of organic acids such as lactic acid. Treatment with an acidic ion exchanger is likewise possible but less preferred.

The branched polyethers or branched polyether carbonates have at least one generation of branching, preferably at least two generations of branching. The expression “generation” here also covers pseudo-generations, as in WO 02/40572.

The ¹³C NMR shifts of the branched polyethers were evaluated by a method based on H. Frey et al., Macromolecules 1999, 32, 4240-4260.

The carbonate segments can be detected analytically by means of ¹³C NMR spectroscopy and IR spectroscopy. Signals are detectable in the range from 155-165 ppm in the ¹³C NMR for the carbonyl carbon of the carbonate ester unit(s). The C═O absorptions of the carbonate ester vibration can be detected in the IR in the wavelength range from 1740-1750 cm⁻¹ and sometimes 1800-1810 cm⁻¹.

The polydispersity (Mw/Mn) of the branched polyether carbonates of the formula (I), determined by means of GPC, is preferably <3.5, with preference <2.5 and with particular preference from >1.05 to <1.8.

A particular embodiment of the synthesis of a branched polyether by the process described, in which the following form an adduct with the allyl alcohol starter: first 4 mol of ethylene oxide, then 3 mol of glycerol carbonate and finally respectively 4 mol of ethylene oxide and propylene oxide, randomly, can, for example, give a molecular constitution depicted in formula (VI) for the branched polyether carbonate. From the structure of formula (VI) it can be seen that only one third of the theoretically possible amount of units M9 provided by the glycerol carbonate has been incorporated. The other two thirds have escaped in the form of CO₂ during the reaction.

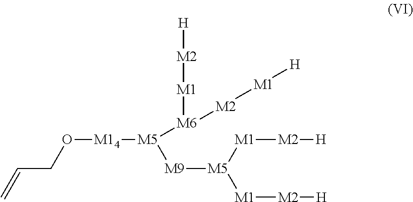

The terminal hydroxy groups of the branched polyethers can remain free or can be modified to some extent or completely, in order to permit optimization of compatibility within the matrix used. Esterification processes or etherification processes are a conceivable modification, as equally are other condensation or addition reactions, with isocyanates, for example. Monoisocyanates used can be compounds such as n-butyl isocyanate, cyclohexyl isocyanate, tolyl isocyanate, or monoadducts of IPDI or MDI, preferably n-butyl isocyanate, tolyl isocyanate, and with particular preference n-butyl isocyanate. Difunctional isocyanates can also be used, for example MDI, IPDI or TDI, but this is less preferred. The terminal hydroxy groups are acetylated or methylated or end-capped with carbonates, or preferably remain free.

It is also possible to use any of the other known ways of modifying hydroxy groups. The chemical reactions mentioned here do not have to be quantitative. It is therefore also possible that the free hydroxy groups have been chemically modified only to some extent, i.e., in particular at least one hydroxy group has been chemically modified. The chemical modification process for the free hydroxy groups of the branched polyether carbonates can be carried out either before or after the hydrosilylation reaction with the Si—H-functional polysiloxane.

Step (b):

The SiH-functional siloxanes are preferably provided in step (b) by carrying out the equilibration process known from the prior art. The prior art describes the equilibration of the branched or linear, optionally hydrosilylated, poly(organo)siloxanes having terminal and/or pendent SiH functions. See, for example, EP 1 439 200 A1, DE 10 2007 055 485 A1 and DE 10 2008 041 601. These documents are hereby incorporated as reference and are considered to be part of the disclosure of the present invention in relation to step (b).

Step (c):

Step (c) preferably takes the form of a hydrosilylation process. Here, the olefinically unsaturated polyether carbonates from step (a) are SiC-bonded to the SiH-functional siloxanes from step (b), by means of noble-metal catalysis.

The silicone polyether block copolymers used can be produced by a process known from the prior art in which branched or linear polyorganosiloxanes having terminal and/or pendent SiH functions are reacted with an unsaturated polyether or with a polyether mixture made of at least two unsaturated polyethers. The reaction preferably takes the form of noble-metal-catalyzed hydrosilylation, as described, for example, in EP 1 520 870. The disclosure of EP 1 520 870 is incorporated hereby as reference and is considered to be part of the disclosure in relation to step (c) of the present invention. In some instances, it is preferable to use a platinum-comprising catalyst as noble-metal catalyst.

The reactions according to step (c) can be carried out in the presence or absence of saturated polyethers. In some embodiments, it is preferable to carry out step (c) in the presence of saturated polyethers. It is possible to carry out step (c) in the presence of solvents other than saturated polyethers. In some embodiments, it is preferable not to use any solvents other than saturated polyethers. Step (c) can also be carried out in the presence of acid buffering agents. However, it is preferably carried out in the absence of acid buffering agents. In some instances, it is preferable that the step is carried out in the absence of acid buffering agents and solvents other than saturated polyethers.

Step (c) can use, besides the branched polyethers, in particular polyether carbonates from (a), other linear and/or branched, unsaturated polyether compounds differing from these. This can be advantageous for permitting compatibilization of the polysiloxanes comprising branched polyethers with the matrix used.

The properties of the polysiloxane used according to the invention can be influenced through different contents of M1 and M2 in the unbranched allyl polyether. For example, the selection of suitable M1:M2 ratios can be used to control the level of hydrophobic or respectively hydrophilic properties of the polysiloxane according to the invention, specifically because the M2 units have a higher level of hydrophobic properties than the M1 units.

In some embodiments, more than just one unbranched allyl polyether can be used. In other embodiments, mixtures of different unbranched allyl polyethers can be used in order to improve control of compatibility.

The polyethers can be produced by any desired processes which can be found in the prior art. Unsaturated starter compounds can be alkoxylated either with base catalysis or with acid catalysis or with double-metal-cyanide (DMC) catalysis. The production and use of DMC alkoxylation catalysts has been known since the 1960s and is described, for example, in U.S. Pat. No. 3,427,256, 3,427,334, 3,427,335, 3,278,457, 3,278,458 or 3,278,459. Since that time, DMC catalysts of even higher effectiveness, specifically zinc-cobalt hexacyano complexes, have been developed, as described, for example, in U.S. Pat. Nos. 5,470,813 and 5,482,908. The chain end of the unbranched allyl polyether can have hydroxy functionality or else, as described above, can have been modified, for example, through methylation or acetylation.

In some embodiments, exclusively unsaturated polyether carbonates or else any desired mixture of the polyether carbonates with unsaturated branched polyethers, where these have no unit M9, can be used. The molar proportion of the unsaturated branched polyether carbonates used to the carbonate-free branched polyethers (polyethers without unit M9) is preferably from 0.001 mol % to 100 mol %, with preference from 0.5 mol % to 70 mol % and with particular preference from 1 mol % to 50 mol %, based on the entirety of unsaturated branched polyether carbonates and of carbonate-free unsaturated branched polyethers.

A feature of the compositions according to the invention for the production of polyurethane foams, where these comprise at least one polyol component, one catalyst catalyzing the formation of a urethane bond or isocyanurate bond, and optionally one blowing agent, is that they also comprise a polysiloxane compound of formula (IV), as defined above, and optionally comprise other additives and optionally comprise an isocyanate component.

Preferred compositions according to the invention are those which comprise from 0.1 to 10% by weight of polysiloxane compounds of the formula (IV). The compositions according to the invention preferably comprise from 0.05 to 10 parts by mass, with preference from 0.1 to 7.5 parts by mass, and with particular preference from 0.25 to 5 parts by mass, of polysiloxane compounds of formula (IV) per 100 parts by mass of polyol components.

The composition according to the invention can comprise, as isocyanate component, any of the isocyanate compounds suitable for the production of polyurethane foams, in particular of rigid polyurethane foams or of rigid polyisocyanurate foams. In some embodiments, it is preferable that the composition according to the invention comprises one or more organic isocyanates having two or more isocyanate functions. Examples of suitable isocyanates for the purposes of this invention are any of the polyfunctional organic isocyanates, such as diphenylmethane 4,4′-diisocyanate (MDI), toluene diisocyanate (TDI), hexamethylene diisocyanate (HMDI) and isophorone diisocyanate (IPDI). A particularly suitable material is the mixture known as “polymeric MDI” (“crude MDI”), made of MDI and of analogues of higher condensation level, having an average functionality of from 2 to 4. Examples of suitable isocyanates are mentioned in EP 1 712 578 A1, EP 1 161 474, WO 058383 A1, U.S. Patent Application Publication No. 2007/0072951 A1, EP 1 678 232 A2 and WO 2005/085310.

The polyol component is preferably different from the compounds of formula (I) and from the siloxane compounds. Polyols suitable for the purposes of this invention are any of the organic substances having a plurality of groups reactive towards isocyanates, and also preparations of these. Preferred polyols are any of the polyether polyols and polyester polyols usually used for the production of polyurethane foams. Polyether polyols are obtained through reaction of polyfunctional alcohols or amines with alkylene oxides. Polyester polyols are based on esters of polyfunctional carboxylic acids (mostly phthalic acid or terephthalic acid) with polyfunctional alcohols (mostly glycols). Appropriate polyols are used in accordance with the properties demanded from the foams, as described, for example, in U.S. Patent Application Publication No. 2007/0072951 A1, WO 2007/111828 A2, U.S. Patent Application No. 2007/0238800, U.S. Pat. No. 6,359,022 B1 or WO 96 12759 A2. Various patent specifications also describe vegetable-oil-based polyols which can be used with preference, examples being WO 2006/094227, WO 2004/096882, U.S. Patent Application Publication No. 2002/0103091, WO 2006/116456 and EP 1 678 232.

If one or more isocyanates is/are present in the composition according to the invention, the ratio of isocyanate to polyol, expressed as index, is preferably in the range from 80 to 500, with preference from 100 to 350. The index here describes the ratio of isocyanate actually used to theoretical isocyanate (for a stoichiometric reaction with polyol). An index of 100 represents a molar ratio of 1:1 for the reactive groups.

The composition according to the invention preferably comprises, as catalyst catalyzing formation of a urethane bond or of an isocyanurate bond, one or more catalysts for the isocyanate-polyol and/or isocyanate-water and/or isocyanate-trimerization reactions. Suitable catalysts for the purposes of the present invention are preferably catalysts which catalyze the gel reaction (isocyanate-polyol), the blowing reaction (isocyanate-water) and/or the di- or trimerization of the isocyanate. Typical examples of suitable catalysts are the amines such as triethylamine, dimethylcyclohexylamine, tetramethylethylenediamine, tetramethylhexanediamine, pentamethyldiethylenetriamine, pentamethyldipropylenetriamine, triethylenediamine, dimethylpiperazine, 1,2-dimethylimidazole, N-ethylmorpholine, tris(dimethylaminopropyl)hexahydro-1,3,5-triazine, dimethylaminoethanol, dimethylaminoethoxyethanol and bis(dimethylaminoethyl)ether, tin compounds, such as dibutyltin dilaurate, tin salts, such as tin 2-ethylhexanoate, and potassium salts, such as potassium acetate and potassium 2-ethylhexanoate. Suitable catalysts are mentioned by way of example in EP 1985642, EP 1985644, EP 1977825, U.S. Patent Application Publication No. 2008/0234402, EP 0656382 B1, U.S. Patent Application Publication No. 2007/0282026 A1 and in the patent specifications cited therein.

Preferred amounts of catalysts present in the composition according to the invention depend on the type of catalyst and are usually in the range from 0.05 to 5 pphp (=parts by mass, based on 100 parts by mass of polyol), or from 0.1 to 10 pphp for potassium salts.

The composition according to the invention can comprise, as an optional blowing agent, water or another chemical or physical blowing agent. Where water is used as the blowing agent, water contents which are suitable for the purposes of this invention depend on whether one or more other blowing agents in addition to the water is/are used or not. In the case of purely water-blown foams the water contents are typically from 1 to 20 pphp, whereas if other blowing agents are also used the amount used decreases to, usually, from 0.1 to 5 pphp. It is also possible to use a composition according to the invention which is entirely water-free.

Where blowing agents other than water are present in the composition according to the invention, these can be physical or chemical blowing agents. In some embodiments, it is preferable that the composition comprises physical blowing agents. Suitable physical blowing agents for the purposes of this invention are gases, for example liquified CO₂, and volatile liquids, for example, hydrocarbons having 4 to 5 carbon atoms, preferably cyclo-, iso- and n-pentane, fluorocarbons, preferably HFC 245fa, HFC 134a and HFC 365mfc, fluorochlorocarbons, preferably HCFC 141b, hydrofluoroolefins, oxygen-containing compounds, such as methyl formate and dimethoxymethane, or chlorocarbons, preferably 1,2-dichloroethane or methylene chloride.

In addition to, or instead of, water and optionally physical blowing agents, chemical blowing agents can also be used, where these react with isocyanates with evaluation of gas, an example being formic acid.

The compositions according to the invention can comprise, as additives, other additives that can be used in the production of polyurethane foams. By way of example, antioxidants, pigments, plasticizers, or solids such as calcium carbonate, or flame retardants, can be used. Additives that are frequently used include, for example, flame retardants.

The composition according to the invention can comprise, as flame retardants, any of the flame retardants that are known and are suitable for the production of polyurethane foams. Suitable flame retardants for the purposes of the invention are preferably liquid organophosphorous compounds, such as halogen-free organic phosphates, e.g., triethyl phosphate (TEP), halogenated phosphates, e.g., tris(1-chloro-2-propyl) phosphate (TCPP) and tris(2-chloroethyl) phosphate (TCEP) and organic phosphonates, e.g., dimethyl methanephosphonate (DMMP), dimethyl propanephosphonate (DMPP), or solids such as ammonium polyphosphate (APP) and red phosphorus. Other suitable flame retardants are halogenated compounds, for example, halogenated polyols, and also solids, such as melamine and expanded graphite.

The composition can optionally also comprise, as other additives, other components known from the prior art, e.g., polyethers, nonylphenol ethoxylates or non-ionic surfactants.

The compositions according to the invention can be used for the production of PU foams. The compositions can be processed to give foams by any of the processes familiar to the person skilled in the art, for example the manual mixing process, or preferably by using high-pressure foaming machinery. In some embodiments batch processes, for example for the production of panels, refrigerators and molded foams, or continuous processes, for example for insulation sheets, metal-composite elements, or slabs, or spray processes can be used.

The polyurethane foam according to the invention is preferably a polyurethane foam produced by the process according to the invention.

The polyurethane foams according to the invention can, for example, be flexible polyurethane foams, rigid polyurethane foams, viscoelastic foams, HR foams, semirigid polyurethane foams, thermoformable polyurethane foams or integral foams. Preferred polyurethane foams according to the invention are flexible polyurethane foams.

A feature of preferred polyurethane foams according to the invention is that the proportion by mass of compounds of formula (IV) is from 0.001 to 5% by mass, based on the weight of the entire foam, preferably from 0.01 to 1.5% by mass.

The polyurethane foams according to the invention can be used, for example, as refrigerator insulation, insulation sheet, sandwich element, pipe insulation, spray foam, single- & 1.5-component canister foam, wood-imitation product, modelling foam, packaging foam, mattresses, furniture cushioning, automobile-seat cushioning, headrest, instrument panel, automobile-interior cladding product, automobile roof lining, sound-deadening material, steering wheel, shoe sole, carpet-backing foam, filter foam, sealant foam, sealant or adhesive.

Test Methods:

The methods described below are preferably used for the determination of parameters or of measured values. In particular, these methods were used in the examples of the present disclosure.

The contents of branching points can be demonstrated by way of example through NMR analysis or MALDI-T of analysis.

The NMR spectra were recorded on a 400 MHz spectrometer from Bruker, using a 5 mm QMP head. Quantitative NMR spectra were recorded in the presence of a suitable accelerator. The specimen to be studied was dissolved in a suitable deuterated solvent (methanol, chloroform) and transferred to 5 mm or 10 mm NMR tubes.

MALDI-T of analysis were conducted on a Shimadzu Biotech Axima (CFR 2.8.420081127) in “reflectron” mode. “Pulse Extraction” was optimized to a molar mass of 1000 g/mol. The specimen was dissolved in chloroform (4-5 g/L) and 2 μL of this solution were applied to graphite as matrix.

The carbonate segments (M9) can be demonstrated through ¹³C NMR analyses or preferably by IR spectroscopy. The M9 units can be demonstrated through bands at wavelengths of about 1745 and sometimes about 1805 in IR spectroscopy.

The IR analyses were carried out on a Tensor 27 IR spectrometer from Bruker Optics, on a diamond, using the “Abandoned total reflection” method. Resolution was 4 cm⁻¹ and 32 sample scans were conducted.

For the purposes of this invention, gel permeation chromatography (GPC) was used to determine weight-average and number-average molecular weights for the polyether carbonates produced, with calibration against a polypropylene glycol standard, and also the final products, calibrated against a polystyrene standard. GPC was conducted on an Agilent 1100 equipped with an RI detector and with an SDV 1000/10 000 Å column combination composed of a 0.8 cm×5 cm preliminary column and two 0.8 cm×30 cm main columns at a temperature of 30° C. and at a flow rate of 1 mL/min (mobile phase: THF). Sample concentration was 10 g/L and injection volume was 20 μL.

Solution-chemistry analysis was conducted by a method based on international standard methods: iodine number (IN; DGF C-V 11 a (53); acid number (AN; DGF C-V 2); OH number (ASTM D4274 C).

In the examples listed below, the present invention is described by way of example, but there is no intention here that the invention, the breadth of application of which is apparent from the entire description and from the claims, be restricted to the embodiments specified in the examples.

### EXAMPLES

### Example 1

### Production of a Branched, Purely EO-Containing Polyether Carbonate

138 g of allyl alcohol and 12.9 g of sodium methylate (sodium methoxide) were used as initial charge under nitrogen in a 5 litre autoclave and the system was evacuated until the internal pressure was 30 mbar. The reaction mixture was heated to 115° C., with stirring, and an addition reaction was carried out at this temperature with 691 g of ethylene oxide. After quantitative reaction of the EO, the reactor contents were deodorized by evacuation to 30 mbar in order to remove any traces of unreacted EO present. The temperature was then increased to 170° C., and 622 g of glycerol carbonate were metered continuously into the system over a period of 2 h. After an after-reaction time of about two hours (identical conditions without any metering of glycerol carbonate into the system) the reaction mixture was cooled to 115° C., and an addition reaction was carried out with a further 1009 g of EO. After an after-reaction time of one hour, the mixture was deodorized and neutralized with 25% phosphoric acid. The OH number of the resultant branched polyether carbonate was 183.1 mg KOH/g and its IN was 24.2 mg I₂/100 g. GPC gave Mp=444, Mw=776, Mn=507 and Mw/Mn=1.5.

### Example 2

### Production of a More Strongly Branched, Purely EO-Containing Polyether Carbonate

119.6 g of allyl alcohol and 11.1 g of sodium methylate were used as initial charge under nitrogen in a 5 litre autoclave and the system was evacuated until the internal pressure was 30 mbar. The reaction mixture was heated to 115° C., with stirring, and an addition reaction was carried out at this temperature with 599.5 g of ethylene oxide. After quantitative reaction of the EO, the reactor contents were deodorized by evacuation to 30 mbar in order to remove any traces of unreacted EO present. The temperature was then increased to 170° C., and 1071 g of glycerol carbonate were metered continuously into the system over a period of 2 h. After an after-reaction time of about three hours (identical conditions without any metering of glycerol carbonate into the system) the reaction mixture was cooled to 115° C., and an addition reaction was carried out with a further 1434 g of EO. After an after-reaction time of one hour, the mixture was deodorized and neutralized with 25% phosphoric acid. The OH number of the resultant branched polyether carbonate was 205.3 mg KOH/g and its IN was 16.8 mg I₂/100 g. GPC gave Mp=456, Mw=885, Mn=545 and Mw/Mn=1.62.

### Example 3

### Production of a Branched, EO- and PO-Containing Polyether Carbonate

116.9 g of allyl alcohol and 10.9 g of sodium methylate were used as initial charge under nitrogen in a 5 litre autoclave and the system was evacuated until the internal pressure was 30 mbar. The reaction mixture was heated to 115° C., with stirring, and an addition reaction was carried out at this temperature with 585.9 g of ethylene oxide. After quantitative reaction of the EO, the reactor contents were deodorized by evacuation to 30 mbar in order to remove any traces of unreacted EO present. The temperature was then increased to 170° C., and 526.8 g of glycerol carbonate were metered continuously into the system over a period of 2 h. After an after-reaction time of about two and a half hours (identical conditions without any metering of glycerol carbonate into the system) the reaction mixture was cooled to 115° C., and an addition reaction was carried out with 1157.3 g of PO. After an after-reaction time of one hour, the mixture was deodorized and neutralized with 25% phosphoric acid. The OH number of the resultant branched polyether carbonate was 175.7 mg KOH/g and its IN was 21.5 mg I₂/100 g. GPC gave Mp=517, Mw=875, Mn=579 and Mw/Mn=1.5.

### Example 4

### Production of a Branched, Purely EO-Containing Polyether by Using Glycidol

138 g of allyl alcohol and 12.9 g of sodium methylate were used as initial charge under nitrogen in a 5 litre autoclave and the system was evacuated until the internal pressure was 30 mbar. The reaction mixture was heated to 115° C., with stirring, and an addition reaction was carried out at this temperature with 691 g of ethylene oxide. After quantitative reaction of the EO, the reactor contents were deodorized by evacuation to 30 mbar in order to remove any traces of unreacted EO present. 390 g of glycidol were then continuously metered in to the mixture over a period of 2 h. After an after-reaction time of about 2 hours (identical conditions without any metering of glycidol into the system), an addition reaction was carried out with a further 1009 g of EO. After an after-reaction time of one hour, the mixture was deodorized and neutralized with 25% phosphoric acid. The OH number of the resultant branched polyether was 196.5 mg KOH/g and its IN was 20.2 mg I₂/100 g.

### Example 5

### Production of a Branched, Purely EO-Containing Polyether by Using a Hydroxyoxetane

A branched polyether was synthesized by a method based on that described in allyl polyether Example 6 of Patent Specification WO 2010/003611.

### Example 6a

### Methylation of a Polyether Carbonate

783 g of the branched polyether carbonate from Example 1 were used as initial charge under inert gas in a 2 litre three-necked flask equipped with distillation bridge, and were heated to 50° C. At this temperature, sodium methylate was slowly added in molar excess. The resultant methanol was removed by distillation. A water-jet vacuum was then applied, the temperature was increased to 115° C. and methyl chloride was introduced into the solution by using a gas-inlet tube for 1.5 h. After another vacuum distillation step, methyl chloride was again introduced over a period of 1 h. This was followed by distillation (115° C. in vacuo), neutralization (with phosphoric acid), and also filtration (paper filter), giving a terminally methylated product with IN 22.6 mg I₂/100 g.

The polyether obtained in Example 2 was methylated analogously.

### Example 6b

### Acetylation of a Polyether Carbonate

563 g of the branched polyether carbonate from Example 1 was used as initial charge together with catalytic amounts of conc. hydrochloric acid under inert gas in a 2 litre three-necked flask equipped with dropping funnel and reflux condenser, and was heated to 85° C. Acetic anhydride was then slowly added. After complete addition, the mixture was stirred for a further 4 h. Any acid residues present were then removed by distillation, giving a terminally acetylated, branched polyether carbonate with iodine number IN 22.7 mg I₂/100 g.

The polyethers obtained from Examples 2 and 3 were acetylated analogously.

TABLE 1
Theoretical constitution of the branched polyethers used below for the production of stabilizers.

| No.* | Starter alcohol Z(Q-H)ⱼ | M | M | M | J |
|---|---|---|---|---|---|
| 1 | Q = O, Z = CH₂═CHCH₂—, j = 1 | M1 i1 = 6.5 | M5-M6 + M9 | M1 i1 = 9.6 | H |
| | | | i5-i6 + i9 = 2 | | |
| 1a | Q = O, Z = CH₂═CHCH₂—, j = 1 | M1 i1 = 6.5 | M5-M6 + M9 | M1 i1 = 9.6 | CH3 |
| | | | i5-i6 + i9 = 2 | | |
| 2 | Q = O, Z = CH₂═CHCH₂—, j = 1 | M1 i1 = 6.5 | M5-M6 + M9 | M1 i1 = | H |
| | | | i5-i6 + i9 = 4 | 15.5 | |
| 2a | Q = O, Z = CH₂═CHCH₂—, j = 1 | M1 i1 = 6.5 | M5-M6 + M9 | M1 i1 = | CH3 |
| | | | i5-i6 + i9 = 4 | 15.5 | |
| 2b | Q = O, Z = CH₂═CHCH₂—, j = 1 | M1 i1 = 6.5 | M5-M6 + M9 | M1 i1 = | C(O)CH3 |
| | | | i5-i6 + i9 = 4 | 15.5 | |
| 3b | Q = O, Z = CH₂═CHCH₂—, j = 1 | M1 i1 = 6.5 | M5-M6 + M9 | M2 i2 = 9.6 | C(O)CH3 |
| | | | i5-i6 + i9 = 2 | | |
| 4 | Q = O, Z = CH₂═CHCH₂—, j = 1 | M1 i1 = 6 | M5-M6 | M1 i1 = 9 | — |
| | | | i5-i6 = 2 | | |
| 5 | Q = O, Z = CH₂═CH—CH₂—O—CH₂—C(CH₂CH₃)(CH₂XH)₂ | M1 i1 = 18 | M12 i12 = 4 | — | H |
| | | | M13 i13 = 8 | | |

*a = methylated end cap, b = acetylated end cap

Besides the branched polyethers according to the invention, previously known unbranched polyethers were also used in the production of the polyethersiloxanes:

PE comp1: allyl alcohol-started, average molar mass=600 g/mol, purely ethylene-oxide-based

PE comp2: allyl alcohol-started, average molar mass=1200 g/mol, ethylene-oxide-propylene-oxide-based, having a proportion by weight of 20% of propylene oxide.

### Example 7

### Production of Hydrosiloxanes According to EP 1439200 A1

The SiH-functional siloxanes used as feedstocks in Example 1 of EP 1439200 A1 and the non-functional siloxanes were mixed and reacted in accordance with the stoichiometry desired. This gave liquid, clear hydrosiloxanes, the structures of which according to formula (IV) are listed in Table 2.

TABLE 2

| | R | R₁ₐ | R_{1b} | R_{P} | R₂ | R₃ | a | b₁ | b₂ | c | d |
|---|---|---|---|---|---|---|---|---|---|---|---|
| Ex. 7a | CH₃ | CH₃ | CH₃ | H | — | — | 51 | 7 | 0 | 0 | 0 |
| Ex. 7b | CH₃ | H | H | H | — | — | 40 | 4 | 0 | 0 | 0 |
| Ex. 7c | CH₃ | CH₃ | CH₃ | H | — | — | 50 | 8 | 0 | 0 | 0 |
| Ex. 7d | CH₃ | CH₃ | CH₃ | H | — | — | 25 | 2 | 0 | 0 | 0 |

### Example 8

### Production of a Polyether-Carbonate-Modified Siloxane

61.7 g of the hydrosiloxanes from Example 7a and 136.2 g of the polyether carbonate from Example 1 were heated to 70° C., with stiffing, in a 500 ml four-necked flask with attached stirrer with precision glass gland, reflux condenser and internal thermometer. A Karstedt catalyst activated according to EP 1520870 A1 was added as catalyst. Conversion determined by gas-volumetric methods was quantitative after 3 hours. This gave an opaque yellow product which with water forms a clear solution.

The other silicone stabilizers used of the formula (IV) were synthesized by analogy with Example 8 by the method described in EP 1520870. The amounts used were selected in such a way that the molar ratios corresponded to those of Example 8. Table 3 lists the attribution of the resultant foam stabilizers.

TABLE 3
Structure and attribution of the stabilizers used in the foaming process

| | Siloxane Ex. | |
|---|---|---|
| Polyether Ex No. | No. | Polyethersiloxane Ex No. |
| 1a | 7a | 8a |
| 2a | 7a | 8b |
| 2b | 7a | 8c |
| 3b | 7a | 8d |
| 1 | 7b | 8e |
| 1 | 7c | 8f |
| 1 | 7d | 8g |
| 1a | 7b | 8h |
| 2 | 7b | 8i |
| 2 | 7c | 8j |
| 4 | 7c | 8k |
| 5 | 7c | 8l |
| PE comp1 (50/50) | 7c | 8m |
| PE comp2 (30/70) | 7c | 8n |

In the polyethersiloxanes 8m and 8n, the two polyethers were used in the stated equivalence ratio, based on allyl functionality.

### Examples 9 to 12

### Production of Flexible Polyurethane Foams

The following formulation was used for the production of the polyurethane foams: 100 parts by weight of polyetherol (hydroxy number=48 mg KOH/g, 11-12% EO), 5 parts by weight of water, 5 parts by weight of methylene chloride, 0.6 part by weight of the silicone stabilizers (PES) according to Table 3 or 4, produced by using the branched polyether polysiloxane examples given in Table 2, 0.15 part by weight of a tertiary amine, 64.2 parts by weight of T 80 toluene diisocyanate (index 115), and also 0.23 part by weight of KOSMOS® 29 (Evonik Industries). In the foaming process 400 g of polyol were used, and the other formulation components were converted accordingly.

For the foaming process, the polyol, water, amine, tin catalyst and silicone stabilizer were thoroughly mixed, with stiffing. After addition of methylene chloride and isocyanate, the mixture was stirred with a stirrer at 3000 rpm for 7 seconds. The resultant mixture was poured into a paper-lined wooden box (basal area 27 cm×27 cm). This gave a foam, which was subjected to the performance tests described below.

Physical Properties of Foams

The foams produced were assessed on the basis of the following physical properties:

a) Amount by which the foam settles after the end of the rise phase (=settling):

Settling or after-rise was calculated from the difference between foam height after direct escape of the blowing gases and 3 min after the blowing gases had escaped from the foam. Foam height was measured by a needle attached to a centimetre scale, at the maximum in the centre of the convex upper surface of the foam.

b) Foam height (=height):

The final height of the foam was determined by taking the settling or after-rise and subtracting this from or, respectively, adding this to the foam height after the blowing gases had escaped.

c) Foam density (FD):

This was determined as described in ASTM D3574-08, Test A, by measuring Core Density.

d) Air permeability/porosity

e) Compressive strength (Compression Load Deflection CLD), 40%

f) Compression set for 70% compression for 22 h at 70° C.

g) Rebound resilience (Ball rebound test) (=rebound)

Tests e) to g) were likewise carried out in accordance with ASTM D3574-08.

Test d) was carried out as follows:

Method:

The air-permeability or porosity of the foam was determined by measuring back pressure on the foam. The back pressure measured was stated in mm of alcohol column, where the lower back pressure values characterize the more open foam. The values were measured in the range from 0 to 300 mm

Apparatus:

The test apparatus was supplied through the in-house nitrogen line, and was therefore attached thereto, and was composed of the following parts connected to one another:

Reducing valve with manometer,
Screw-thread flow regulator,
Wash bottle,
Flow measurement equipment,

### T-piece,

Applicator nozzle,
Scaled glass tube, containing alcohol.

The wash bottle is only essential if the apparatus was not supplied from the in-house line, but instead was supplied directly with gas from an industrial cylinder.

Before first operation of the flow measurement equipment, this requires calibration in accordance with the manufacturer's instructions, using the calibration curves supplied with the equipment, and should be marked at 8 L/min=480 L/h.

The specification for the applicator nozzle was: edge length 100×100 mm, weight from 800 to 1000 g, gap width of outflow aperture 5 mm, gap width of lower applicator ring 30 mm

The test liquid (technical grade alcohol (ethanol)) can be colored slightly in order to increase visual contrast.

Test Procedure:

The reducing valve was used to adjust the ingoing nitrogen pressure to 1 bar. The screw-thread flow regulator was used to regulate flow to the appropriate 480 L/h. Alcohol was used to bring the amount of liquid in the scaled glass tube to a level such that the pressure difference arising and readable is zero. The actual test on the test specimen used five individual measurements, four at the four corners and one in the centre of the test specimen. For this, the applicator nozzle was superposed flush with the edges at the corners, and the centre of the test specimen was estimated. The pressure read-out was used to determine when constant back pressure had been achieved.

Evaluation:

The upper measurement limit of the method was 300 mm liquid column (LC). For purposes of recording of the results, three different situations needed to be distinguished:

All five values were below 300 mm LC. In this situation, the arithmetic average was calculated and recorded.

All five values were greater than or equal to 300 mm LC. In this situation, the value recorded was >300 or, respectively, 300.

Among the five values measured there was a) explicitly determinable values, and b) values greater than or equal to 300: the arithmetic average was calculated from five values, and the value 300 was used for each of the b) values. The number of values greater than or equal to 300 was also recorded, separated by an oblique from the average value.

### Example

Four measured values: 180, 210, 118 and 200 mm LC; one measured value >300 mm LC, giving (180+210+118+200+300)/5. Entry in records: 202/1.

Table 4 collates the results.

TABLE 4
Physical properties of flexible foams of Examples 9 to 12, produced using
stabilizers comprising branched polyethers

| | | Full rise | | | Foam | | CLD | | |
|---|---|---|---|---|---|---|---|---|---|
| Ex. | PES | time | Settling | Height | density | Porosity | 40% | Compression | Rebound |
| No. | No. | [s] | [cm] | [cm] | [kg/m³] | [mm] | [kPa] | set | [%] |
| 9 | 8a | 83 | 2.2 | 32.2 | 18.4 | 7 | 3.8 | 5.3 | 42 |
| 10 | 8b | 82 | 3.5 | 30.5 | 19.4 | 6 | 3.8 | 6.2 | 42 |
| 11 | 8c | 89 | 2.2 | 30.2 | 18.6 | 8 | 3.6 | 5.1 | 43 |
| 12 | 8d | 85 | 0.8 | 32.3 | 17.6 | 19 | 3.7 | 5.3 | 37 |

Table 4 shows that stable flexible foams with very good physical properties can be produced without difficulty by using silicone polyether stabilizers according to the invention. The structure of these stabilizers includes at least one branching point in the polyether.

### Examples 13 to 15

### Production of Rigid Polyurethane Foams

The foam processes used the manual mixing process. For this, polyol, flame retardant, catalysts, water, conventional foam stabilizer or foam stabilizer according to the invention and blowing agent were weighed into a cup and mixed at 1000 rpm for 30 s with a stirrer disc (diameter 6 cm). The amount of blowing agent vaporized during the mixing procedure was determined by reweighing and in turn replaced. The isocyanate (MDI) was then added, the reaction mixture was mixed at 3000 rpm for 5 s with the stirrer described, and in the case of the free-rise foams it was poured into a paper-lined box with basal area 27 cm×14 cm. In the case of the refrigerator formulation, the mixture was transferred to a thermostatic aluminium mould lined with polyethylene film. The amount used here of the foam formulation was 15% by mass greater than the amount needed to give the minimum charge to the mold.

The foams were analyzed one day after the foaming process. In the case of free-rise foams, the basal zone of the foam was visually assessed, and a cut surface in the upper portion of the foam was also used for visual assessment of degree of internal disruption and pore structure on the basis of a scale from 1 to 10, where 10 represents a fully satisfactory foam and 1 represents a foam with an extremely high level of disruption. Test specimens were then cut out of the material for a fire test for classification in accordance with DIN 4102, this being known as the “B2 test”. The maximum flame height was determined during combustion of the test specimen, and the value achieved must be below 150 mm to pass the test.

In the case of the molded foams, surface and internal disruption were likewise assessed subjectively on the basis of a scale from 1 to 10. Pore structure (average number of cells per cm) was assessed visually on a cut surface by comparison with comparative foams. Coefficient of thermal conductivity (λ value) was measured on slices of thickness 2.5 cm at temperatures of 10° C. and 36° C. for the lower and upper side of the specimen, by using Hesto Lambda Control equipment.

### Examples 13 to 15

### Free-Rise Rigid Foam

The rigid PU foam system used for the free-rise foams is specified in Table 5.

TABLE 5
Formulation of free-rise rigid foams

| Component | Proportion by weight | |
|---|---|---|
| Daltolac R 471* | 60 | parts |
| Terate 203** | 40 | parts |
| Tris(1-chloro-2-propyl) phosphate | 40 | parts |
| N,N,N′,N″,N″-Pentamethyldiethylenetriamine | 0.2 | part |
| N,N-Dimethylcyclohexylamine | 2.0 | parts |
| Water | 1.0 | part |
| Foam stabilizer | 1.0 | part |
| Solkane 141b | 25 | parts |
| Desmodur 44V20L**** | 140 | parts |

*Polyether polyol from Huntsman
**Polyester polyol from Invista
*** Polyester polyol from Stepan
**** Polymeric MDI from Bayer

Table 6 gives the results for the free-rise foams.

TABLE 6
Results for free-rise foams

| | Stabilizer | Internal defects | Pore structure | Basal zone | |
|---|---|---|---|---|---|
| Ex. | from Ex. | (1-10) | (1-10) | (1-10) | B2 test |
| 13 | 8e | 9 | 8 | 9 | 140 mm |
| 14 | 8i | 10 | 8 | 9 | 140 mm |
| 15 | 8m | 9 | 9 | 9 | 140 mm |

Examples 12 to 14 show that the polyethersiloxanes according to the invention can be used to produce PU foams which have good flame-retardant properties.

### Examples 16 to 25

### Rigid PU Foam System for Insulation of Domestic Refrigeration Equipment

A formulation adapted to this application sector was used (see Table 7), and in each case was foamed with foam stabilizers according to the invention. The reaction mixture was introduced into an aluminium mold of size 145 cm×14.5 cm×3.5 cm, thermostated to 45° C.

TABLE 7
Refrigerator-insulation formulation

| Component | Parts by weight |
|---|---|
| Daltolac R 471* | 100 parts |
| N,N-Dimethylcyclohexylamine | 1.5 parts |
| Water | 2.6 parts |
| Cyclopentane | 13.1 parts |
| Stabilizer | 1.5 parts |
| Desmodur 44V20L** | parts |

*Polyether polyol from Huntsman
**Polymeric MDI from Bayer

The results shown in Table 8 lead to the conclusion that the stabilizers according to the invention are suitable for producing polyurethane foams with low thermal conductivities and good surface qualities.

TABLE 8
Results for refrigerator insulation

| | Stabilizer | Defects (1-10) | | λ value/ |
|---|---|---|---|---|
| Ex. | from Ex. | upper/lower/internal | Cells/cm⁻¹ | mW/m * K |
| 16 | 8e | 7/4/6 | 35-39 | 22.6 |
| 17 | 8f | 6/3/6 | 35-39 | 22.7 |
| 18 | 8g | 7/4/6 | 35-39 | 22.5 |
| 19 | 8h | 8/5/7 | 35-39 | 22.7 |
| 20 | 8i | 7/5/6 | 40-44 | 22.4 |
| 21 | 8j | 6/4/6 | 40-44 | 22.6 |
| 22 | 8k | 6/4/6 | 40-44 | 22.4 |
| 23 | 8l | 7/4/6 | 40-44 | 22.3 |
| 24 | 8m | 7/5/6 | 40-44 | 22.3 |
| 25 | 8n | 7/5/6 | 40-44 | 22.6 |

As shown by the experiments, the stabilizers according to the invention provide a suitable alternative to the use of unbranched polyethersiloxanes in the production of rigid foam.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A process for producing polyurethane foams, comprising reacting at least one polyol and at least one isocynate compound in the presence of a catalyst and at least one polysiloxane compound of formula (IV) 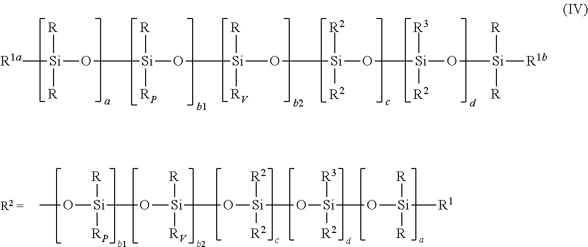
in which
a is mutually independently from 0 to 2000,
b1 is mutually independently from 0 to 60,
b2 is mutually independently from 0 to 60,
c is mutually independently from 0 to 10,
d is mutually independently from 0 to 10,
R is at least one moiety comprising linear, cyclic or branched, saturated or unsaturated hydrocarbon moieties having from 1 to 20 carbon atoms or is an aromatic hydrocarbon moiety having from 6 to 20 carbon atoms,
R¹ is mutually independently R or —OR⁴,
R^{1a} is mutually independently R, R_{V}, R_{P} or —OR⁴,
R^{1b} is mutually independently R, R_{V}, R_{P} or —OR⁴,
R³ is mutually independently R or a saturated or unsaturated, organic moiety,
R⁴ is mutually independently an alkyl moiety having from 1 to 10 carbon atoms,
R_{P} is mutually independently —OR⁴ or hydrogen or is unbranched polyether moieties bonded by way of Si—C bonds and made of alkylene oxide units having from 1-30 carbon atoms, of arylene oxide units and/or of glycidyl ether units with a weight-average molar mass from 200 to 30 000 g/mol, and/or an aliphatic and/or cycloaliphatic and/or aromatic polyester or polyetherester moiety with a weight-average molar mass from 200 to 30 000 g/mol bonded by way of Si—C bonds,
R_{V} is a moiety of the formula (Ia) linked by way of an Si—C bond
—Z′(-Q-M1ᵢ₁-M2ᵢ₂-M3ᵢ₃-M4ᵢ₄-M5ᵢ₅-M6ᵢ₆-M7ᵢ₇-M8ᵢ₈-M9ᵢ₉-M10ᵢ₁₀-M11ᵢ₁₁-M12ᵢ₁₂-M13ᵢ₁₃-Jᵢ₁₄)ᵢ(X-J)ₖ (Ia)
where
i=from 1 to 10,
k=from 0 to 9,
i+k=from 1 to 10,
i1 to i14=respectively mutually independently from 0 to 500,
Q=identical or different, O, NH, N-alkyl, N-aryl or S,
Z=any desired organic moiety, where each Q is bonded to a carbon atom of the organic moiety,
J is mutually independently hydrogen, a linear, cyclic or branched, aliphatic or aromatic, saturated or unsaturated hydrocarbon moiety having from 1 to 30 carbon atoms, a carboxylic acid moiety having from 1 to 30 carbon atoms or a functional, saturated or unsaturated organic moiety substituted with heteroatoms, 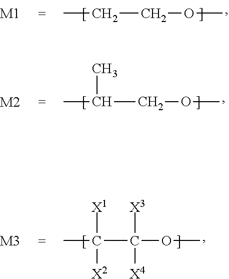
where X¹ to X⁴ are mutually independently hydrogen or linear, cyclic or branched, aliphatic or aromatic, saturated or unsaturated hydrocarbon moieties having from 1 to 50 carbon atoms, with the proviso that the selection of X¹ to X⁴ is not such that M3 is identical with M1 or M2, 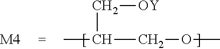
where Y is mutually independently a linear, cyclic or branched, aliphatic or aromatic, saturated or unsaturated hydrocarbon moiety having from 2 to 30 carbon atoms and can also comprise heteroatoms, 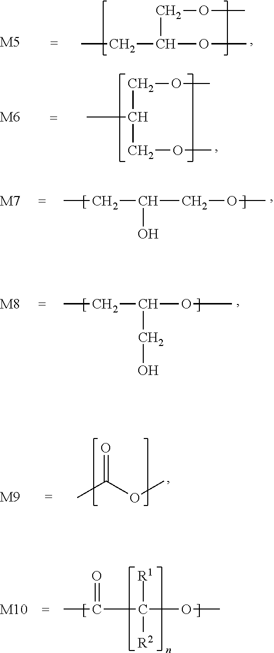
where R¹ and R² are mutually independently either hydrogen, alkyl group, alkoxy group, aryl group or aralkyl group, and n are mutually independently from 3 to 8, where n, R¹ and R² in each M10 unit can be identical or different, 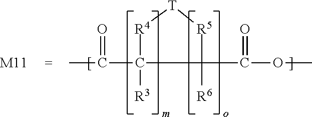
where R³, R⁴, R⁵ and R⁶ are mutually independently either hydrogen, alkyl groups, alkenyl groups, alkyliden groups, alkoxy groups, aryl groups or aralkyl groups and the moieties R⁴ and R⁵ can have cycloaliphatic or aromatic bridging by way of the fragment T, optionally the moieties R³ and R⁶ can form a bond, m and o can be mutually independently from 1 to 8, the units with the indices o and m can be arranged randomly, T is a divalent alkylene or alkenylene moiety and the indices m and o and the radicals T, R³, R⁴, R⁵ and R⁶ in each unit M11 can be identical or different, 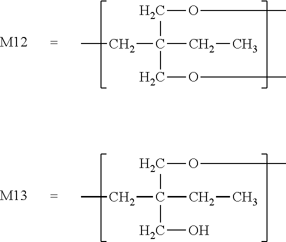
where the monomers M1 to M13 are arranged in any desired ratios, either blockwise, in alternation, or randomly, or else can exhibit a distribution gradient, and where the monomers M1 to M4 are freely permutable, with the provisos that i9>0, that at least one unit M12, M5 or M6 is present for which there is no moiety J directly adjoining at any end and there is at least one unit selected from M1, M2 and M3 adjoining at each end, and that two monomer units of the type M9 do not occur in succession,
where on average at least one moiety R_{V} is present per molecule of formula (IV),
with the proviso that the sum of b1 and b2=b, that the average number Σa of the D units per molecule of the formula (IV) is not greater than 2000, and the average number Σb of the R_{P}- and R_{V}-bearing units per molecule is not greater than 100, and the average number Σc+d per molecule is not greater than 20, and
averaged over all of the compounds obtained of the formula (IV), at most 20 mol % of
the moieties R_{P}, R¹, R^{1a} or R^{1b} are of the type —OR⁴.

2. The process according to claim 1, wherein Σi5+i6≧i+1.

3. The process according to claim 1, wherein R_{V} comprises at least one structural unit which arises through binding of the monomer unit M9 directly to a unit selected from M5, M6, M7 or M8.

4. A composition suitable for producing polyurethane foams which comprises at least one polyol component, at least one catalyst catalyzing formation of a urethane bond or isocyanurate bond, and at least one polysiloxane compound of formula (IV) 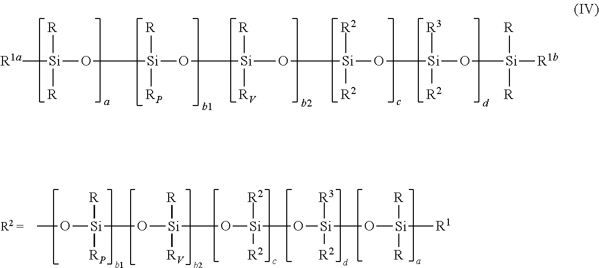
in which
a is mutually independently from 0 to 2000,
b1 is mutually independently from 0 to 60,
b2 is mutually independently from 0 to 60,
c is mutually independently from 0 to 10,
d is mutually independently from 0 to 10,
R is at least one moiety comprising linear, cyclic or branched, saturated or unsaturated hydrocarbon moieties having from 1 to 20 carbon atoms or is an aromatic hydrocarbon moiety having from 6 to 20 carbon atoms,
R¹ is mutually independently R or —OR⁴,
R^{1a} is mutually independently R, R_{V}, R_{P} or —OR⁴,
R^{1b} is mutually independently R, R_{V}, R_{P} or —OR⁴,
R³ is mutually independently R or a saturated or unsaturated, organic moiety,
R⁴ is mutually independently an alkyl moiety having from 1 to 10 carbon atoms, R_{P} is mutually independently —OR⁴ or hydrogen or is unbranched polyether moieties bonded by way of Si—C bonds and made of alkylene oxide units having from 1-30 carbon atoms, of arylene oxide units and/or of glycidyl ether units with a weight-average molar mass from 200 to 30 000 g/mol, and/or an aliphatic and/or cycloaliphatic and/or aromatic polyester or polyetherester moiety with a weight-average molar mass from 200 to 30 000 g/mol bonded by way of Si—C bonds,
R_{V} is a moiety of the formula (Ia) linked by way of an Si—C bond
—Z′(-Q-M1ᵢ₁-M2ᵢ₂-M3ᵢ₃-M4ᵢ₄-M5ᵢ₅-M6ᵢ₆-M7ᵢ₇-M8ᵢ₈-M9ᵢ₉-M10ᵢ₁₀-M11ᵢ₁₁-M12ᵢ₁₂-M13ᵢ₁₃-Jᵢ₁₄)ᵢ(X-J)ₖ (Ia)
where
i=from 1 to 10,
k=from 0 to 9,
i+k=from 1 to 10,
i1 to i14=respectively mutually independently from 0 to 500,
Q=identical or different, O, NH, N-alkyl, N-aryl or S,
Z′=any desired organic moiety, where each Q is bonded to a carbon atom of the organic moiety,
J is mutually independently hydrogen, a linear, cyclic or branched, aliphatic or aromatic, saturated or unsaturated hydrocarbon moiety having from 1 to 30 carbon atoms, a carboxylic acid moiety having from 1 to 30 carbon atoms or a functional, saturated or unsaturated organic moiety substituted with heteroatoms, 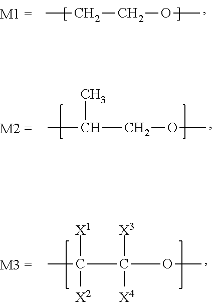
where X¹ to X⁴ are mutually independently hydrogen or linear, cyclic or branched, aliphatic or aromatic, saturated or unsaturated hydrocarbon moieties having from 1 to 50 carbon atoms, with the proviso that the selection of X¹ to X⁴ is not such that M3 is identical with M1 or M2, 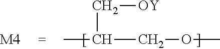
where Y is mutually independently a linear, cyclic or branched, aliphatic or aromatic, saturated or unsaturated hydrocarbon moiety having from 2 to 30 carbon atoms and can also comprise heteroatoms, 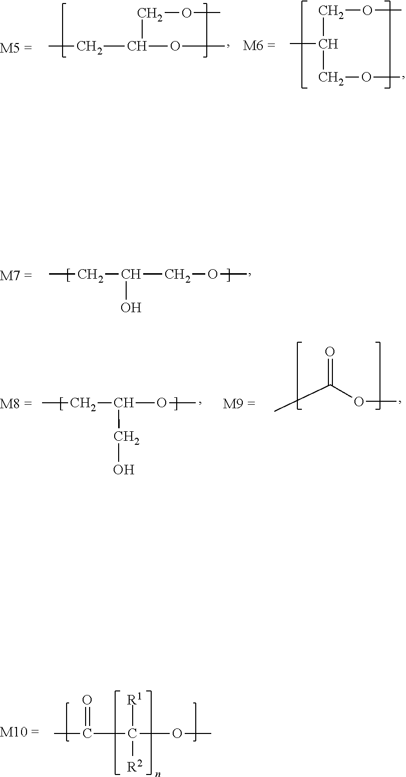
where R¹ and R² are mutually independently either hydrogen, alkyl group, alkoxy group, aryl group or aralkyl group, and n are mutually independently from 3 to 8, where n, R¹ and R² in each M10 unit can be identical or different, 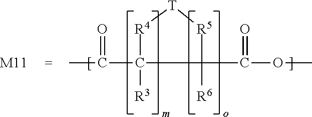
where R³, R⁴, R⁵ and R⁶ are mutually independently either hydrogen, alkyl groups, alkenyl groups, alkyliden groups, alkoxy groups, aryl groups or aralkyl groups and the moieties R⁴ and R⁵ can have cycloaliphatic or aromatic bridging by way of the fragment T, optionally the moieties R³ and R⁶ can form a bond, m and o can be mutually independently from 1 to 8, the units with the indices o and m can be arranged randomly, T is a divalent alkylene or alkenylene moiety and the indices m and o and the radicals T, R³, R⁴, R⁵ and R⁶ in each unit M11 can be identical or different, 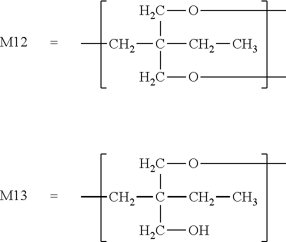
where the monomers M1 to M13 are arranged in any desired ratios, either blockwise, in alternation, or randomly, or else can exhibit a distribution gradient, and where the monomers M1 to M4 are freely permutable, with the provisos that i9>0, that at least one unit M12, M5 or M6 is present for which there is no moiety J directly adjoining at any end and there is at least one unit selected from M1, M2 and M3 adjoining at each end, and that two monomer units of the type M9 do not occur in succession,
where on average at least one moiety R_{V} is present per molecule of formula (IV),
with the proviso that the sum of b1 and b2=b, that the average number Σa of the D units per molecule of the formula (IV) is not greater than 2000, and the average number Σb of the R_{P}- and R_{V}-bearing units per molecule is not greater than 100, and the average number Σc+d per molecule is not greater than 20, and
averaged over all of the compounds obtained of the formula (IV), at most 20 mol % of the moieties R_{P}, R¹, R^{1a} or R^{1b} are of the type —OR⁴.

5. The composition according to claim 4, further comprises a blowing agent.

6. The composition according to claim 4, further comprising an isocynate component.

7. A composition of matter comprising a polyurethane foam and at least one polysiloxane compound of formula (IV) 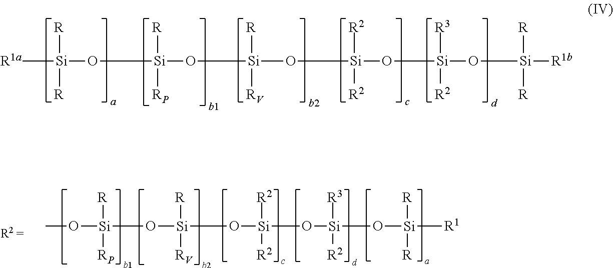
in which
a is mutually independently from 0 to 2000,
b1 is mutually independently from 0 to 60,
b2 is mutually independently from 0 to 60,
c is mutually independently from 0 to 10,
d is mutually independently from 0 to 10,
R is at least one moiety comprising linear, cyclic or branched, saturated or unsaturated hydrocarbon moieties having from 1 to 20 carbon atoms or is an aromatic hydrocarbon moiety having from 6 to 20 carbon atoms,
R¹ is mutually independently R or —OR⁴,
R^{1a} is mutually independently R, R_{V}, R_{P} or —OR⁴,
R^{1b} is mutually independently R, R_{V}, R_{P} or —OR⁴,
R³ is mutually independently R or a saturated or unsaturated, organic moiety,
R⁴ is mutually independently an alkyl moiety having from 1 to 10 carbon atoms,
R_{P} is mutually independently —OR⁴ or hydrogen or is unbranched polyether moieties bonded by way of Si—C bonds and made of alkylene oxide units having from 1-30 carbon atoms, of arylene oxide units and/or of glycidyl ether units with a weight-average molar mass from 200 to 30 000 g/mol, and/or an aliphatic and/or cycloaliphatic and/or aromatic polyester or polyetherester moiety with a weight-average molar mass from 200 to 30 000 g/mol bonded by way of Si—C bonds,
R_{V} is a moiety of the formula (Ia) linked by way of an Si—C bond
—Z′(-Q-M1ᵢ₁-M2ᵢ₂-M3ᵢ₃-M4ᵢ₄-M5ᵢ₅-M6ᵢ₆-M7ᵢ₇-M8ᵢ₈-M9ᵢ₉-M10ᵢ₁₀-M11ᵢ₁₁-M12ᵢ₁₂-M13ᵢ₁₃-Jᵢ₁₄)ᵢ(X-J)ₖ (Ia)
where
i=from 1 to 10,
k=from 0 to 9,
i+k=from 1 to 10,
i1 to i14=respectively mutually independently from 0 to 500,
Q=identical or different, O, NH, N-alkyl, N-aryl or S,
Z′=any desired organic moiety, where each Q is bonded to a carbon atom of the organic moiety,
J is mutually independently hydrogen, a linear, cyclic or branched, aliphatic or aromatic, saturated or unsaturated hydrocarbon moiety having from 1 to 30 carbon atoms, a carboxylic acid moiety having from 1 to 30 carbon atoms or a functional, saturated or unsaturated organic moiety substituted with heteroatoms, 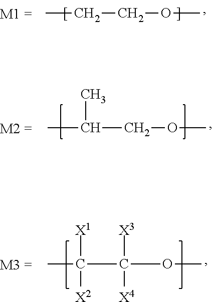
where X¹ to X⁴ are mutually independently hydrogen or linear, cyclic or branched, aliphatic or aromatic, saturated or unsaturated hydrocarbon moieties having from 1 to 50 carbon atoms, with the proviso that the selection of X¹ to X⁴ is not such that M3 is identical with M1 or M2, 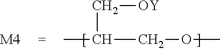
where Y is mutually independently a linear, cyclic or branched, aliphatic or aromatic, saturated or unsaturated hydrocarbon moiety having from 2 to 30 carbon atoms and can also comprise heteroatoms, 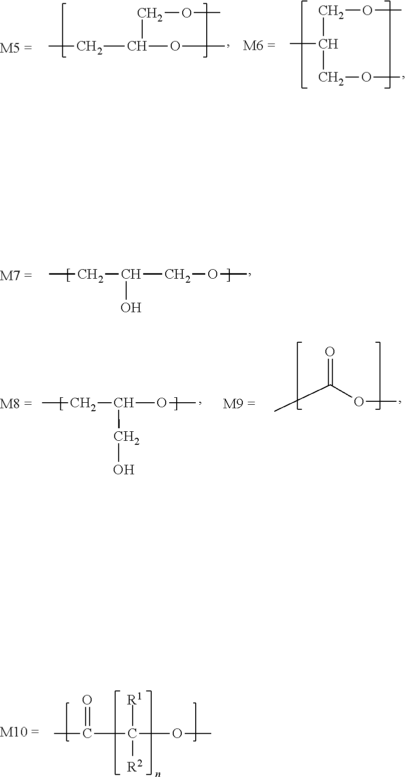
where R¹ and R² are mutually independently either hydrogen, alkyl group, alkoxy group, aryl group or aralkyl group, and n are mutually independently from 3 to 8, where n, R¹ and R² in each M10 unit can be identical or different, 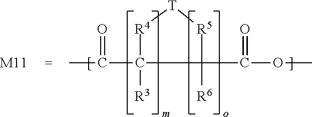
where R³, R⁴, R⁵ and R⁶ are mutually independently either hydrogen, alkyl groups, alkenyl groups, alkyliden groups, alkoxy groups, aryl groups or aralkyl groups and the moieties R⁴ and R⁵ can have cycloaliphatic or aromatic bridging by way of the fragment T, optionally the moieties R³ and R⁶ can form a bond, m and o can be mutually independently from 1 to 8, the units with the indices o and m can be arranged randomly, T is a divalent alkylene or alkenylene moiety and the indices m and o and the radicals T, R³, R⁴, R⁵ and R⁶ in each unit M11 can be identical or different, 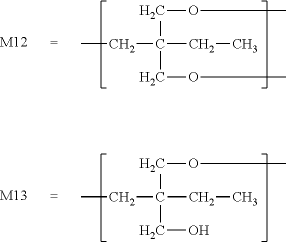
where the monomers M1 to M13 are arranged in any desired ratios, either blockwise, in alternation, or randomly, or else can exhibit a distribution gradient, and where in particular the monomers M1 to M4 are freely permutable, with the provisos that i9>0, that at least one unit M12, M5 or M6 is present for which there is no moiety J directly adjoining at any end and there is at least one unit selected from M1, M2 and M3 adjoining at each end, and that two monomer units of the type M9 do not occur in succession,
where on average at least one moiety R_{V} is present per molecule of formula (IV),
with the proviso that the sum of b1 and b2=b, that the average number Σa of the D units per molecule of the formula (IV) is not greater than 2000, and the average number Σb of the R_{P}- and R_{V}-bearing units per molecule is not greater than 100, and the average number Σc+d per molecule is not greater than 20, and
averaged over all of the compounds obtained of the formula (IV), at most 20 mol % of the moieties R_{P}, R¹, R^{1a} or R^{1b} are of the type —OR⁴.

8. The composition of matter according to claim 7, wherein said polyurethane foam is a flexible polyurethane foam.

9. An article of manufacturing comprising the composition of matter of claim 7.

10. The article of manufacturing according to claim 9, wherein said article is selected from the group consisting of furniture, refrigerator-insulation materials, other means of insulation or insulation sheets, packaging materials, sandwich elements, spray foams, single- & 1.5-component canister foams, wood-imitation products, modelling foams, packaging foams, mattresses, furniture cushioning, automobile-seat cushioning, headrests, instrument panels, automobile-interior cladding products, automobile roof lining, sound-deadening materials, steering wheels, shoe soles, carpet-backing foams, filter foams, sealant foams, sealants and adhesives.
